(19) United States
(12) Patent Application Publication
(10) Pub. No.: US 2008/0033799 A1
(43) Pub. Date: Feb. 7, 2008

(54) System for dynamic logical control of personalized object placement in a multi-media program

(75) Inventors: Daniel B. McKenna, Steamboat Springs, CO (US); George Kauss, San Antonio, TX (US); James M. Graziano, Hotchkiss, CO (US)

Correspondence Address: PATTON BOGGS LLP, 1801 CALFORNIA STREET, SUITE 4900, DENVER, CO, 80202, US

(73) Assignee: Vulano Group, Inc., San Antonio, TX (US)

(21) Appl. No.: 11/486,862

(22) Filed: Jul. 14, 2006

(51) Int. Cl. G06Q 30/00

(52) U.S. Cl. 705/14

(57) ABSTRACT

The multi-media object management system functions to manage the delivery of product placements in a Multi-Media Program The multi-media object management system controls the retrieval of Object Data that comprises a product representation and the integration of this Object Data into a corresponding selected one of the predetermined Multi-Media Object Locations which are components of the Multi-Media Program This enables advertisers to precisely control product placement on a customized basis thereby to dynamically modify the content of the Multi-Media Program on a centralized basis, a regional basis, or as it is delivered to the individual recipient. The matching of an Object with the Multi-Media Object Location is effected via rules that match the Object Characteristics with the Object Management Data associated with the Multi-Media Object Location and a Master Rule Set.

### CROSS-REFERENCE TO RELATED APPLICATIONS

This application is related to an application titled “System For Managing The Purchasing Of Dynamic Personalized Object Placement In A Multi-Media Program” filed on the same date hereof, and to an application titled “Network Architecture For Dynamic Personalized Object Placement In A Multi-Media Program” filed on the same date hereof, and to an application titled “System For Product Placement Rendering In A Multi-Media Program” filed on the same date hereof, and to an application titled “System For Dynamic Recipient-Specific Object Placement In A Multi-Media Program” filed on the same date hereof, and to an application titled “System For Creating Dynamically Personalized Media” filed on the same date hereof, and to an application titled “Digital Rights Management In Dynamic Personalized Object Placement In A Multi-Media Program” filed on the same date hereof, and to an application titled “System For Dynamic Personalized Object Placement In A Multi-Media Program” filed on the same date hereof.

### FIELD OF THE INVENTION

The present invention relates to the field of Multi-Media Programs that are delivered to recipients and to a system that enables the dynamic placement of Object likenesses in predefined locations in the Multi-Media Program, as reserved by predefined Multi-Media Object Locations, to correlate the product placement in the Multi-Media Program with the Object preferences of the recipient.

### BACKGROUND OF THE INVENTION

It is a problem in the field of multi-media content to provide the advertiser with the flexibility to deliver a set of advertisements that target a specific audience or recipient on a dynamic basis. The present-day efficiency of mass media advertising is very low—advertising dollars do not achieve high levels of purchase decisions due to lack of recipient targeting. “Commercial Break” advertising interrupts the flow of a program's content, and consumer devices enable recipients to completely skip the “commercial break”. New media devices such as e-readers for books or magazines are presently not personalized. Likewise, the delivery of video content to mobile devices such as cell phones, while in its infancy, is not contemplated to be personalized; hence, the advertising across this new media also is not personalized. Similarly, multi-media programming on the Internet may offer ads such as banners or other ad forms that essentially overlay displayed content, none of which are targeted or dynamically targeted. Current multi-media products and services do not permit highly targeted advertising, an archaic paradigm in which the recipients' needs, wants, and desires are not directly influenced; rather, these needs, wants, and desires can be missed entirely.

Devices such as DVRs digital Video Recorders) and TiVo enable recipients to completely bypass mass media and targeted commercial breaks by simply 37 fast-forwarding” the broadcasted multi-media content to bypass the commercials. This recipient action effectively negates the delivered value of traditional multi-media content advertising. In addition, the traditional ad insertion methods for television and radio do not permit continuous flow of multi-media content like that when going to a movie theater to see a feature length movie. The advertising interrupted multi-media content does not provide an optimum viewing or listening experience for the recipient.

Concepts such as static product placement directly into the multi-media content stream have the advantage that it is virtally impossible for the recipient to bypass the “product placement advertisement” using DVR technology. However, the present art for static product placement does not provide the capability to dynamically change the inserted product to match the demographic, psychographic, or sociographic characteristics of the recipient. Thus, the opportunity to micro-advertise directly to a given recipient using product placement is technologically unavailable.

The traditional method of advertising has been to broadcast a common advertisement to a large audience via mass media, such as newspapers, magazines, radio, and television. This mass media advertising strategy seeks to reach the greatest number of recipients thereby to increase the odds of contacting the recipients most likely to purchase the advertised product or service. Although a large viewing audience may see the advertisement, advertisers understand that only a small percentage of that audience has a real interest in purchasing the advertised product or service.

To offset this unnecessary spending, advertisers continually strive to narrow advertising efforts to a targeted purchasing audience. The importance of measuring advertising's effectiveness is critical—it determines whether an ad campaign will be effective and also enables the advertiser to more effectively manage the productiveness of a given advertising campaign. These objectives are so important that organizations such as Nielsen are planning to track advertising popularity or viewership. One targeting advertising method distributes commercials, which are inserted into the media stream at predetermined program break locations, to attract demographic groups likely to purchase the advertised product or service. For example, television shows often appeal to a particular type of audience, marked perhaps by age, income, or education. Usually, the specific sponsors of the shows sell products that appeal to the same particular audience. In addition, cable and satellite broadcast systems can insert commercials at predetermined program break locations on a regional basis to target local audiences with local commercials. For example, a television broadcaster in Denver may insert and play a Chevrolet ad, while in Boston, the ad slot is replaced or “cut-out” and an Audi ad is inserted. For “zip code” advertising, the cable TV head-end may insert a unique advertisement in a broadcasted TV program for a given zip code (which may or may not have similar recipient demographic attributes depending on the demographic make-up of the “zip code” region). Still, even these levels of advertising granularity do not solve the problem of eliminating the insertion of an advertisement and breaking the continuous flow of the multi-media content stream; furthermore, the advent of DVRs enable the recipient to completely bypass even these more highly targeted ads. In addition, other technologies are also now available to mute or skip over these commercials, so their advertising impact is nullified (the technologies “sense” or know when the content stream switches from program material to commercials and skips or deletes the commercials).

In another consumer targeting method, advertisers pay the mass media content creator to deliver advertisements as an integral part of the media content, and this process is termed “product placement.” This method embeds the advertisement in the mass media content such that the recipient views the advertisement as part of the media content. For example, actors or actresses use the advertiser's products during their acting, or the products are prominently displayed as part of the stage set during the program. For example, a television program could contain 30-second commercial breaks and static product placements. These types of product placements are static and become a permanent part of the television program or movie.

Traditionally, product placement is a form of advertising that is done in the creation of the static original multi-media content to present “advertising” to the recipient without interrupting the program stream for a formal, traditional commercial (e.g., break the program stream delivery and insert a 30-second advertisement). The prominent placement of a product as part of the multi-media content generates brand recognition with the recipients in a manner that is far more subtle and unobtrusive than traditional commercials. In fact, it can actually create a higher brand awareness because of the direct actor-actress interaction with the product (or service).

In a feature length movie, advertising is implemented using the strategy of product placement—a Coke can being held by an actor has the effect of creating brand awareness for Coca-Cola®. However, this product placement is static in its implementation since the feature length movie always has the same graphical rendition of the original Coke can (when the movie was made), even though the feature length movie could become a classic that is re-played many years in the future. It is presently not possible to dynamically modify the original Coke can to represent the present day rendition of the new, modern Coke can, say, 10 years hence.

Unfortunately, present-day product placement suffers from some of the same drawbacks of broadcast commercials, since they are immutable and delivered to the entire audience, with no ability to dynamically modify the product placement to target selected audience segments or individual recipients; nor can the product placements be updated over time.

### BRIEF SUMMARY OF THE INVENTION

The above-described problems are solved and a technical advance achieved in the field by the present System For Dynamic Personalized Object Placement In A Multi-Media Program (termed “multi-media object management system” herein) which functions to manage the delivery of Object (product) placements in a Multi-Media Program. The multi-media object management system controls the retrieval of Object Data that comprises a product representation and the integration of this Object Data into a corresponding selected one of the predetermined Multi-Media Object Locations which are components of the Multi-Media Program. This enables advertisers to precisely control Object (product) placement on a customized basis thereby to dynamically modify the content of the Multi-Media Program on a centralized basis, regional basis, or at the individual recipient's location.

In the multi-media object management system, the production of the Master Program that is used to create the Multi-Media Program typically results in the presence of a plurality of Objects within the Master Program. The multi-media object management system defines a plurality of Multi-Media Object Locations within the Master Program as components of the Multi-Media Program and creates Object Management Data that is used to control the population of these spatial and temporal Multi-Media Object Locations with Objects. These Multi-Media Object Locations can receive animation, audio, moving Objects, stationary Objects, and any other dynamic data. The Multi-Media Object Locations are an integral part of the Multi-Media Program, and their content can be manipulated by referencing a specified Multi-Media Object Location and populating that specified Multi-Media Object Location with a predetermined rendition from the Objects stored in the database. Thus, the image of a beverage can in a Multi-Media Program is populated by any of a number of specific brands of beverages by importing a predetermined representation of the desired brand of beverage into the pre-defined Multi-Media Object Location that is an integral part of the Multi-Media Program. The multi-media object management system enables dynamic product placement in the delivery of a program to a recipient.

In addition, by collecting data on recipient viewing habits and analyzing that data in light of other recipient account information (from other databases), the multi-media object management system is able to intelligently select and display products or services to a recipient who is truly interested in purchasing these displayed products or services. Further, the multi-media object management system can deliver different advertisements to different recipients watching the same program or channel. Thus, the multi-media object management system reaches a large audience (e.g., a cable television audience), assesses the interests and tastes of each recipient of that audience, and delivers imbedded advertisements to each recipient for products or services that the recipient is predisposed to purchase. The net result is a more efficiently spent advertising dollar for the sponsors and an increased profit margin for the network media providers.

The purchase of the Multi-Media Object Locations for placement of products is a flexible and dynamic process. The purchasing is done via an Object Location Brokerage process where advertisers can purchase Multi-Media Object Locations on an international national, regional, local, or personal level to target groups of recipients or even individual recipients. In addition, the purchase can be effected via an auction paradigm or can be managed by selling reserved rights or conditional rights, where a selected Multi-Media Object (Product) Location is sold for a target geographic area; but the price only reserves the Multi-Media Object Locations if a subsequent purchaser fails to outbid the first purchaser. The types of purchasing scenarios are numerous and only a few are described herein to simplify the description of the process, not to limit the possibilities.

Imagine a whole new promotional paradigm where standard commercials as we know them become a thing of the past, a world where 60-minute television shows are really 60 minutes instead of 45 minutes of content and 15 minutes of commercials.

In the new world of “in situ advertising”, 30-second commercial breaks become a thing of the past. Products and services now become dynamic Objects (product placements), easily manipulated and adapted based on national, regional, state, local, or even individual household delivery standards as set by advertisers and consumers alike. In this world, not only can an advertiser choose to tailor their delivery to a specific audience, the consumer can also choose which products they are most interested in seeing and thus most likely to purchase (pull advertising versus traditional push advertising). This ultimate degree of matching advertising to a given recipient is unparalleled.

As we move into an era where promoting products and services via standard commercial television is becoming less and less effective because of the sheer number of choices of available channels each having a content focus, and with the advent of digital video recorders that allow for either cutting out commercials entirely or fast forwarding through them, a new and innovative advertising delivery method is necessary to effectively deliver required and critical advertising and promotional messages while still successfully engaging the recipient to continue watching the show of their choice without interruptions.

With “in situ advertising”, goods and services can now be promoted by directly inserting them into the very fabric of the show being viewed in a dynamic fashion that is substantially flexible and manageable from a very high level (national items such as Coke®, Pepsi®, Ford® or McDonald's®) down to an extremely local level that can be targeted to an individual household (grocery store, restaurant, dry cleaner, beauty salon, etc.) The idea of promotional product placement is not a new one; what is innovative in this process is that the promotional placement can be dynamically changed and adapted to highly precise market and delivery conditions.

Traditionally, product placement has been limited to whatever placement can be done at the time of filming or content creation. The future involves a process whereby all product placement is infinitely dynamic and flexible because it can be changed at will and by location and by recipient's profile. This allows marketers to focus their promotional needs to an exact target market, raising the propensity to buy to the highest level.

### BRIEF DESCRIPTION OF THE DRAWINGS

FIG. 1 illustrates, in flow diagram form, the flow of program materials in the multi-media object management system;

FIG. 2 shows the integration of various content types in the multi-media object management system;

FIG. 3A illustrates, in block diagram form, the overall architecture of the multi-media object management system using a centralized Object insertion paradigm;

FIG. 3B illustrates, in block diagram form, the overall architecture of the multi-media object management system using a regional Object insertion paradigm;

FIGS. 3C and 3D illustrate, in block diagram form, two overall architectures of the multi-media object management system using a localized recipient-based Object insertion paradigm;

FIG. 4A illustrates, in block diagram form, the overall architecture of a typical content source system;

FIG. 4B illustrates, in flow diagram form, the operation of a typical content source system;

FIG. 5A illustrates, in block diagram form, the overall architecture of a typical Object insertion processor,

FIG. 5B illustrates, in flow diagram form, the operation of a typical Object insertion processor;

FIG. 6 illustrates, in block diagram form, a typical system for profiling the interests of recipients in a cable television network;

FIG. 7 illustrates, in flow diagram form, the operation of a typical system for profiling the interests of recipients in a cable television network;

FIGS. 8A-8D illustrate a frame of a Multi-Media Program and a plurality of renderings of the frame using different Objects to populate the Multi-Media Object Location shown in FIG. 8A;

FIG. 9 illustrates a sequence of three sequential frames of a Multi-Media Program and a rendering of the sequence of sequential frames using a selected Object to populate the Multi-Media Object Location in the sequence of three frames which form a Multi-Media Object Location “Set”;

FIG. 10 illustrates the distribution of a single frame of a Multi-Media Program to multiple Recipients in multiple Regions with the Multi-Media Object Location in the frame being populated with different Objects for each Region;

FIG. 11A illustrates an example of a product placement database having a series of Multi-Media Object Locations inserted at various points; and

FIG. 11B illustrates the architecture of one embodiment of an object location brokerage.

### DETAILED DESCRIPTION OF THE INVENTION

Traditionally, product placement is a form of advertising that is done in the creation of the original Multi-Media Program to present “advertising” to the recipient without interrupting the program for a formal, traditional commercial. The prominent placement of a product as part of the program functions to generate brand recognition with the program recipients in a manner that is far more subtle and unobtrusive than traditional commercials.

The present multi-media object management system controls the retrieval of Object Data that comprises an Object Rendition and Object Characteristics and the integration of this Object Data into a corresponding selected one of the predetermined Multi-Media Object Locations which are components of the Multi-Media Program. This enables advertisers to precisely control product placement on a customized basis thereby to dynamically modify the content of the Multi-Media Program on a centralized basis, a regional basis, and/or as it is delivered to the individual recipient. The delivery can also be based on demographic, psychographic or sociographic groupings, which may or may not be geographically proximate.

In the present multi-media object management system, the process of creating the Multi-Media Program takes “Master Program” content and typically defines a plurality of Multi-Media Object Locations (although at least one Location is considered to be the minimalist subset) together with Object Management Data which is collectively termed herein as “Object-Ready Content”. These Multi-Media Object Locations are sites in the Master Program that can receive animation, audio, moving Objects, stationary Objects, and any other dynamic data, whether uni-dimensional, two-dimensional, three-dimensional, or multi-dimensional. The Object-Ready Content is now ready to receive selected Objects.

The purchase of the Multi-Media Object Locations for placement of products is a flexible and dynamic process. The purchasing is done via an Object Location Brokerage process where advertisers can purchase Multi-Media Object Locations on an international, national, regional, or local level to target groups of recipients or even individual recipients. In addition, the purchase can be effected via an auction paradigm or can be managed by selling reserved rights or conditional rights, where a selected Multi-Media Object Location is sold for a target area, but in one embodiment the price only reserves the locations if a subsequent purchaser fails to outbid the first purchaser. The auction process could be “real” time or just-in-time to maximize the value of a given Multi-Media Object Location; an example would be Atomic skis buying an Object Location at the last second just before delivery to a recipient (or the world of recipients) if one of its athletes just won a Gold Medal in the Olympics. It is anticipated that the pricing strategies for Multi-Media Object Locations will involve an economic market that will be far reaching and massively interconnected in its extent. The types of purchasing scenarios are numerous and only a few are described herein to simplify the description of the process, not to limit the possibilities.

The Object selection process for a given Multi-Media Object Location having spatial and temporal attributes is finally processed by reconciling Object Characteristic Data with Object Management Data together with Master Program Rule Set information and Recipient Data (not always necessary or available; in particular, if the Object insertion is done in the central architecture, there would not be any Recipient Data). In addition, the Object Location Brokerage can have bidirectional connections to the Reconcile Processor, as needed. This reconciliation process ensures that the purchase process has not resulted in the placement of inappropriate objects or the selection of an object that cannot be used to populate the selected Multi-Media Object Location. The output of this complex process is the Multi-Media Program.

### DEFINITIONS

In order to ensure a proper understanding of the present multi-media object management system, the following definitions are provided to clarify the terminology used herein.

Master Program—the Master Program produced by the creative staff as the essential “story” being presented in the Multi-Media Program. A Master Program can take the form of a movie, a television show, an Internet short clip, a mobile TV news program, an audio stream, a video stream, an e-magazine on an e-reader using digital ink, and the like.

Master Program Rule Set—a set of rules defined by the originator or owner of the Master Program to regulate the options available to the multi-media object management system to place Objects into the Master Program at the defined Multi-Media Object Locations.

Multi-Media Object Location—spatial and temporal locations in the Master Program that can receive animation, audio, moving Objects, stationary Objects and any other dynamic data, whether uni-dimensional, two-dimensional, three-dimensional, or multi-dimensional.

Object-Ready Content—a copy of the Master Program once it is processed to incorporate the Multi-Media Object Locations and associated Object Management Data.

Object Management Data—Object centric information that is part of the Object-Ready Content and is used to define the attributes of the Multi-Media Object Locations, such as the Object type, the Object location, the time and place or extent in the Multi-Media Program where a Multi-Media Object Location occurs, the number of dimensions that a given Object has (video and audio or just video, for example) and how long an Object “lives”.

Object—a uni-dimensional or multi-dimensional entity (or product or thing or item or article) having Object Characteristics. An Object may be a product representation, an image likeness of a living being such as a dog or a person's face, and the like. Objects can be dynamic or static, depending on the advertising objective. An Object can also be other than multi-media, such as in the case of a document of document-like display.

Object Characteristic Data—the set of data that defines the content of an Object, including the class of Object, identification of the owner of the Object, and limitations (if any) on the use of the Object and so on. The characteristics or attributes of an Object can be uni-dimensional or multi-dimensional and can include but are not limited to: video (moving images), still images, audio, audio that is matched with a given Object, other senses such as feel-smell-taste, and the like. An Object such as a cup of coffee could have a brand logo, an image, and an aroma. A typical Object Characteristic would be two-dimensional having an image (or visualization or rendering) and an associated sound clip.

Object Insertion Process—the means and methods for inserting Objects into Multi-Media Object Locations.

Recipient Data—the demographic, psychographic or sociographic profile of a given recipient that can include the viewing habits of the recipient on an aggregate or temporal basis.

Merged Content Stream—a combination of the Object-Ready Content with only a subset of the Multi-Media Object Locations populated.

Multi-Media Program—the Object-Ready Content with all of the Multi-Media Object Locations populated and ready for delivery to a recipient.

### Flow of Program Materials in the Multi-Media Object Management System

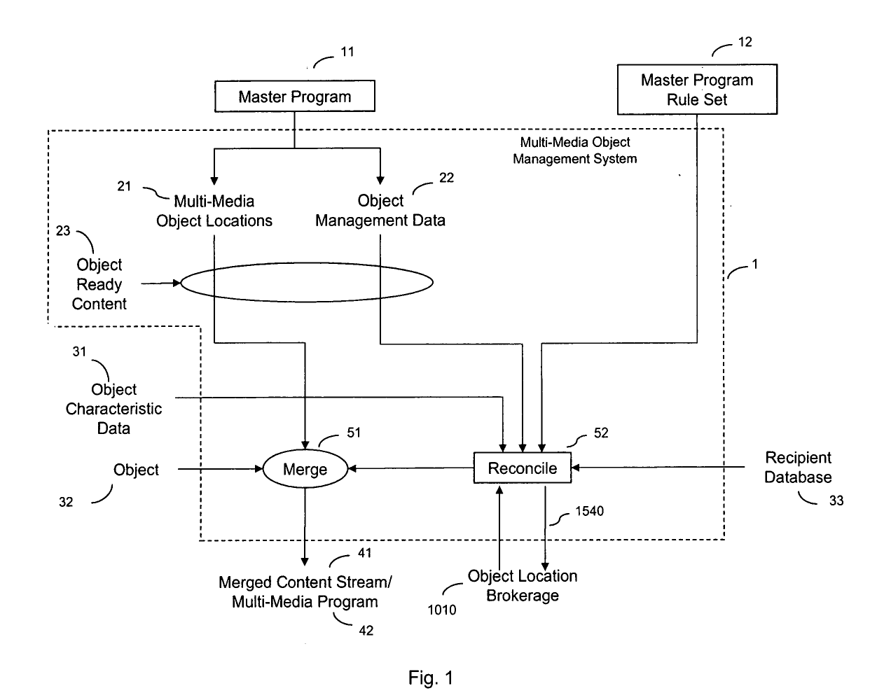

FIG. 1 illustrates, in flow diagram form, the flow of program materials in the multi-media object management system. The Master Program 11 is the master multi-media content that is produced by the creative staff of a multi-media production company as the essential “story” being presented in the Multi-Media Program 42. This can be a television show, a movie, or other such multi-media presentation. Similarly, it could also be an e-magazine delivered electronically to an e-reader using digital ink In the creation of the Master Program 11, various “props” are typically used as stage setting or as part of the story line and these can include motor vehicles, beverage containers, signage, furniture, etc. These props can be non-standard products that are designed to have characteristics that facilitate automatic detection by a processing program (such as a traditional chroma-key blue- or green-colored “prop”), or they can be standard products. While this is one algorithm or method to create the Multi-Media Object Locations 21, the Multi-Media Object Locations 21 can also be created electronically after the Master Program 11 has been finished through manual or other automatic means. The Master Program Rule Set 12 is a set of rules defined by the originator or owner of the Master Program 11 to regulate the Object insertion options available to the multi-media object management system to place Objects 32 into the Master Program 11 at the defined Multi-Media Object Locations 21. This rule set can operate generically on certain defined classes of products or can specifically target predetermined Objects 32 in the Master Program 11. As an example, the originator or owner of the Master Program 11 may have strong beliefs concerning smoking and would prohibit cigarette advertising in their owned content.

The Master Program 11 and its associated Master Program Rule Set 12 are received by the multi-media object management system 1 and then processed to identify Multi-Media Object Locations 21 contained in the Master Program 11 that are to be used for Object placement in conjunction with Object Management Data 22. The Objects 32 can be identified uniformly throughout the Master Program 11 (every instance of an Object 32) or can be selectively targeted. The multi-media object management system 1 creates Multi-Media Object Locations 21, which are sites in the Master Program 11 that can receive animation, audio, moving Objects, stationary Objects, and any other dynamic data, whether uni-dimensional, two-dimensional, three-dimensional, or multi-dimensional. Each of these Multi-Media Object Locations 21 have associated therewith Object Management Data 22 which are Object centric information that is associated with the Multi-Media Object Location 21, such as the Object type, the Object location, the time and place or extent in the Multi-Media Program 42 where an Object 32 occurs, the number of dimensions that a given Object 32 has (video and audio or just video, for example) and how long an Object 32 “lives”. Once the processing of the Master Program 11 is completed, the resultant product is termed Object-Ready Content 23 and consists of a copy of the Master Program 11 once it is processed to contain the Multi-Media Object Locations 23 and the associated Object Management Data 22.

The Object-Ready Content 23 comprises the processed Master Program 11 and Object Management Data 22 and is described below as being transported directly or via a Distribution Network 120 from the Content Source 101 to the Object Insertion Processor 110 in order to provide the content stream that can be populated with selected Objects 32. However, the Object-Ready Content 23 that is stored in Content Source 101 can be written to removable media for physical distribution to locations where the Object Insertion Processor 101 resides. Thus, conceptually, the Distribution Network 120 can comprise a physical media delivery operation. The Object-Ready Content 23 produced by the Content Source 101 itself becomes a product that can be sold to recipients for use in their personal media players (such as a DVD or High Definition DVD or some future technology such as a 3-D media disk and player). The personal media player, when connected to a communications network or using its own memory which is populated with Objects, can retrieve the Object-Ready Content 23 from the removable media, access the Object Source 102 to retrieve the selected Objects 32, and populate the Multi-Media Object Locations 21 in the Object-Ready Content 23 to produce the Multi-Media Program for display to the recipient on their personal media player. A further example of this capability is where the recipient purchases the Multi-Media Program at a retail outlet, but also presents a removable media that contains Objects written thereon for insertion into the Multi-Media Program to personalize the Multi-Media program As an example, the recipient's media can contain Objects that comprise likenesses of the recipient and/or various acquaintances, which likenesses are to be merged into the Multi-Media Program, appearing for example as extras or bit players in a movie, or providing the recipient's favorite products in the Multi-Media Program.

In addition, there is a processing operation that takes place to create Objects 32, which are product representations, each of which has associated therewith Object Characteristics 31 consisting of the set of data that defines the content of an Object 32, and associated data including the class of the Object, identification of the owner of the Object, and limitations (if any) on the use of the Object. Therefore, the Objects 32 consist of the elements that are used to populate the Multi-Media Object Locations 21 that have been created within the Object-Ready Content 23.

Once the Object-Ready Content 23 stream is scheduled to be delivered to recipients, a Merged Program Stream 41 is created, which consists of a combination of the Object-Ready Content 23 with a full set or a subset of the Object 32 locations populated. The Multi-Media Object Locations 23 are populated on a centralized, regional, and/or localized basis (or demographic, psychographic, or sociographic groups which may or may not be geographically proximate) by a merge function 51, and the final product is the Multi-Media Program 42 which consists of the Object-Ready Content 23 with all of the Multi-Media Object Locations 21 populated and ready for delivery to a recipient.

The population of the Multi-Media Object Locations 21 with Objects 32 is controlled not only by the appropriateness of the Object 32 in the Master Program 11 as identified by the Master Program Rules Set 12 and the Object Characteristic Data 31, but also by the purchasing of the Multi-Media Object Locations 21 by advertisers to have their products displayed in the Multi-Media Program 42 as identified in the Object Location Brokerage 1010 and the recipient-specific characteristics as identified in Recipient Database 33. There are numerous procedures that can be used to effect the purchase and management of the Multi-Media Object Locations 21, and these result in the creation of a set of attribution data that defines the particular Object 32 that is to be used to populate a selected Multi-Media Object Location 21, subject to the Master Program Rule Set 12, the Object Characteristic Data 31, and the Object Management Data 22 confirming the selection (and optionally the Recipient Data 33). The management of the Multi-Media Object Locations is performed in the Reconcile Processor 52 to ensure that the proper Object 32 is populated into the proper Multi-Media Object Location 21.

### Examples of Multi-Media Object Population of Multi-Media Object Locations

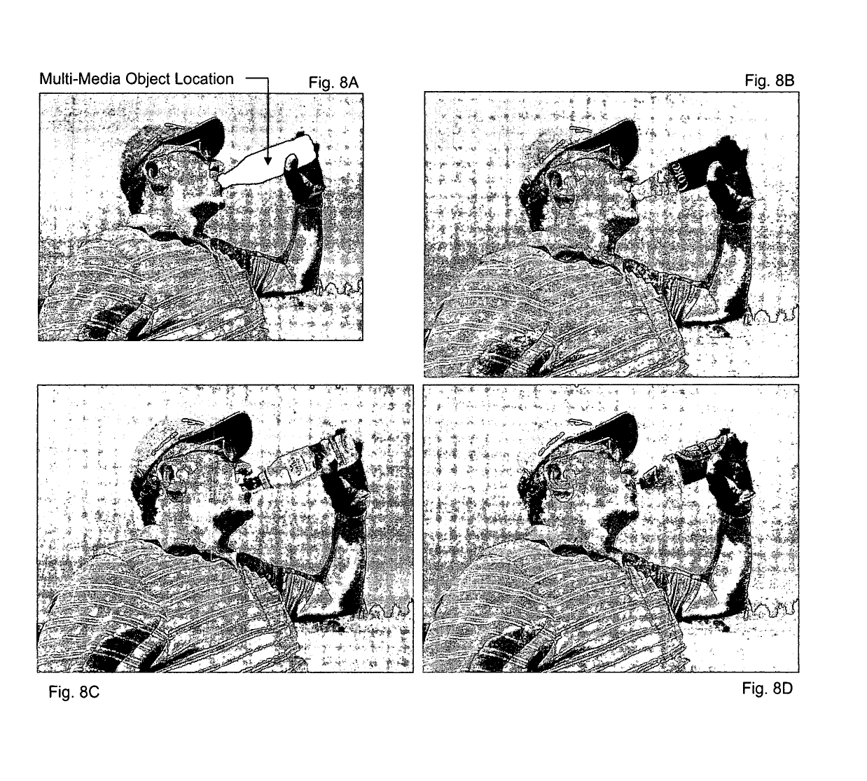

FIGS. 8A-8D illustrate a frame of a Multi-Media Program and a plurality of renderings of the frame using different Objects to populate the Multi-Media Object Location shown in FIG. 8A. In particular, FIG. 8A illustrates a subject holding a “blank” beverage container to drink from the beverage container (shown in white or clear space which is the Multi-Media Object Location). In FIG. 8A, the beverage container is a Multi-Media Object Location, and its extent in this frame of the Multi-Media Program is delineated by the “white” area in the image. As can be seen from this image, the full extent of the beverage container is obscured in part by the subject's hand in holding the beverage container, where such obscuration is often typical of a Multi-Media Object Location.

Any number of Objects can be selected to populate this Multi-Media Object Location, and the examples illustrated herein in FIGS. 8B-8D are illustrative of the various products that can be used to populate the Multi-Media Object Location. These Object insertions can occur on a centralized, regional or local basis, so the same image, personalized by the insertion of a selected Object (product), can be delivered to various groups of recipients or individual recipients as described below. It is also necessary in the use of an Object to populate a Multi-Media Object Location, to adapt the Object to correspond to the extent of the Multi-Media Object Location. Thus, a “stock” Object may have to be dynamically modified to account for the subject's hand shown in the frame, the size of the Object may have to be proportionately adjusted to be consistent with the location in the frame (foreground, background, perspective view, etc.), and the boundary between the Object as inserted into the selected Multi-Media Object Location may have to be “morphed”. Alternatively, the “background” layer “behind” and “in front of” the Object can also be “morphed” to wrap-around or fit into the inserted Object should the Multi-Media Object Location be different than that of the selected Object. This background and foreground modification can be modified using predictive algorithms well known in the art. In addition, the characteristics of the Object may be adjusted, using well-known image processing techniques, so the rendition of the Object, in terms of hue, saturation, color, brightness, etc., are consistent with the surroundings in the frame.

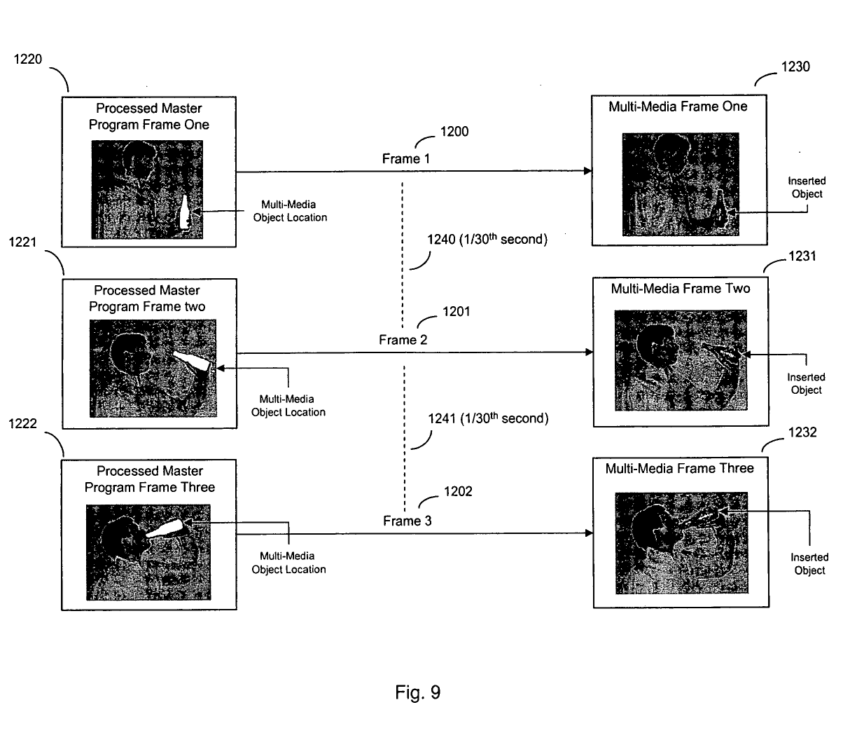

FIG. 9 illustrates a sequence of three frames of a Multi-Media Program and a rendering of the sequence of frames using a selected Object to populate the Multi-Media Object Location shown in the sequence of three frames. The three images 1220-1222 represent a sequence of three frames 1200-1202 of a Processed Master Program, presented to the recipient as Multi-Media Program frames 1230-1232 at the traditional rate 1240, 1241 ( 1/30 sec. for television and 1/24 sec. for movies). Each image 1220-1222 of the Processed Master Program includes a Multi-Media Object Location, which in this instance is a beverage container. The subject in this sequence of frames is lifting the beverage container to their lips to drink from the beverage container. The Multi-Media Object Locations in these three frames represent a set of Multi-Media Object Locations and are managed uniformly, in that the same Object is used to populate the three frames since there is a consistency of theme in this sequence of frames. Thus, as can be seen from FIG. 9, the Multi-Media Object Location in each of the frames 1220-1222 of the Processed Master Program have been populated with an Object comprising a representation of a particular brand of beverage container, resulting in the three frames of the Multi-Media Program 1230-1232 including the inserted Object as if it were in the original rendition of the Master Program 11. An advertiser would, in this example, purchase all three Multi-Media Object Locations in the three video (movie) frames thereby forming a “Set” of Multi-Media Object Locations.

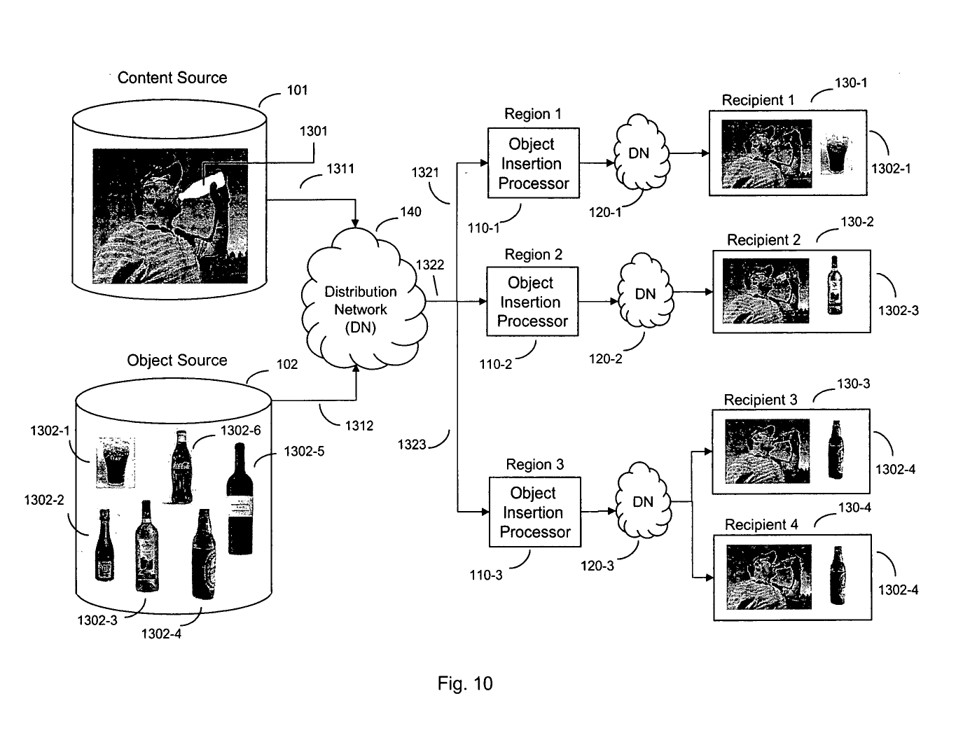

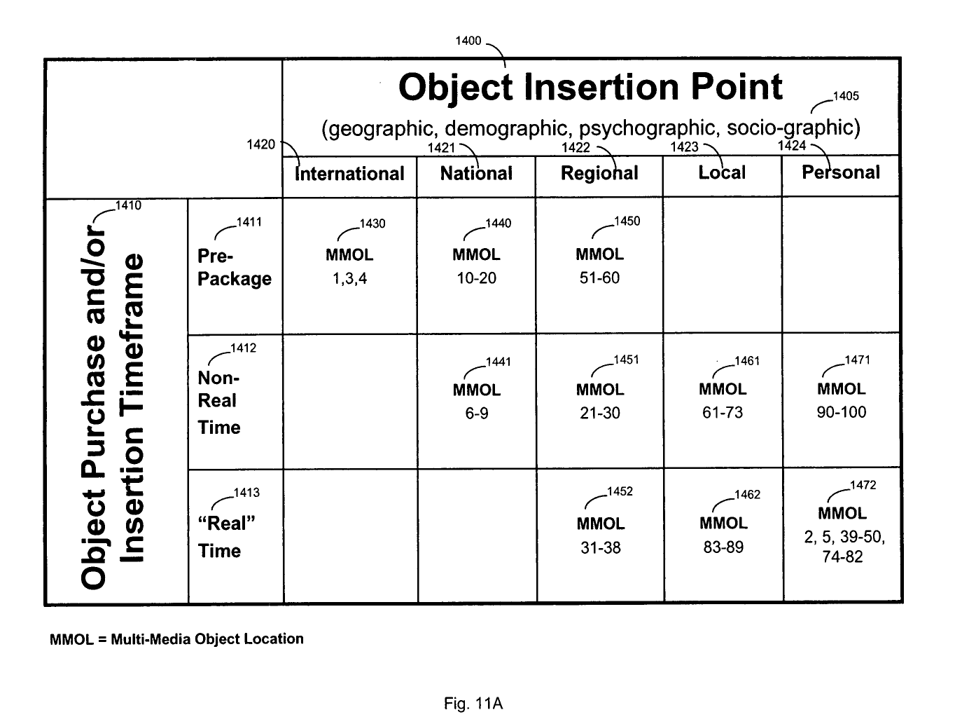

FIG. 10 illustrates the distribution of a single frame of a Multi-Media Program to multiple Recipients in multiple Regions with the Multi-Media Object Location in the frame being populated with a different Object for each Region. In this instance, the Content Source 101 is delivering Object-Ready Content via path 1311 to Distribution Network 140 and thence via paths 1321-1323 to multiple Object Insertion Processors 110-1 to 110-3. Similarly, the Object Source 102 contains a plurality of Objects 1302-1 to 1302-6 that are of the same class as the Multi-Media Object Location 1301 illustrated in the image frame shown in FIG. 10. Each Object Insertion Processor 110-1 to 110-3 serves a particular Region (Region 1-3) of the area served by the multi-media object management system and can select any of the Objects 1302-1 to 1302-6 that are appropriate for populating the selected Multi-Media Object Location 1301, as defined by the purchase decision managed by the Object Location Brokerage 1010 (not shown on this Figure). Each Multi-Media Object Location purchase results in the associated Object Insertion Processor 110-1, for example, retrieving an Object 1302-1 from the Object Source 102 and using the retrieved Object 1302-1 to populate the selected Multi-Media Object Location 1301.

Thus, as can be seen from FIG. 10, while the Object Insertion Processor 110-1 selected Object 1302-1 to populate Multi-Media Object Location 1301 to create image 1302-1 for delivery via Distribution Network 120-1 to Recipient 130-1, the Object Insertion Processor 110-2 selected Object 1302-3 to populate Multi-Media Object Location 1301 to create image 1302-3 for delivery via Distribution Network 120-2 to Recipient 130-2, and the Object Insertion Processor 110-3 selected Object 1302-4 to populate Multi-Media Object Location 1301 to create image 1302-4 for delivery via Distribution Network 120-3 to Recipients 130-3 and 130-4, resulting in three different renderings of the same frame of the Multi-Media Program appearing in the three different Regions, delivered to four different Recipients.

### Dynamic Object Insertion Using an Integrated Centralized, Regional, and Local Architecture

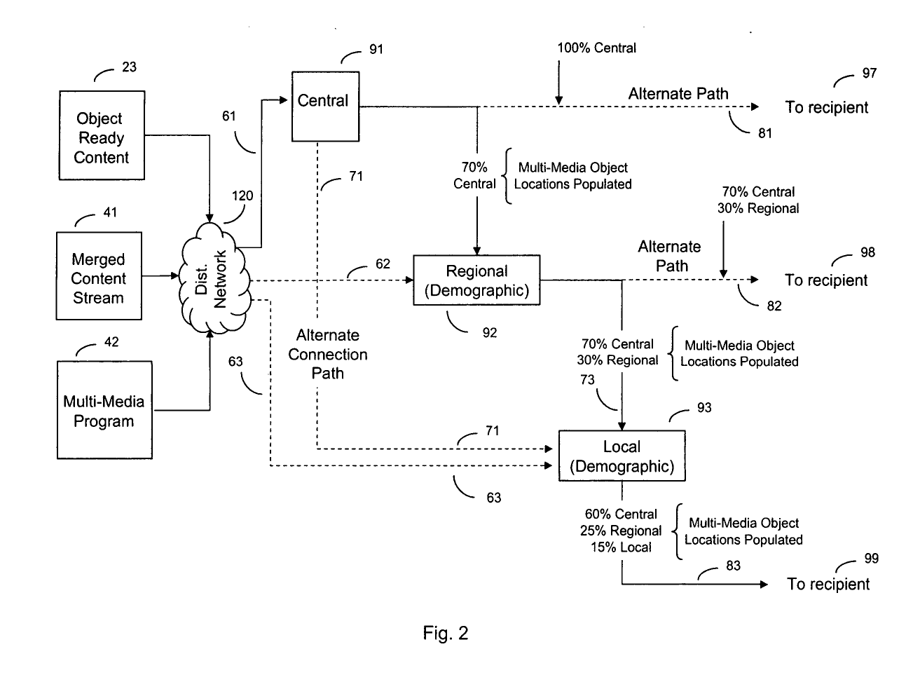

FIG. 2 shows the integration of various content types in the multi-media object management system: Object-Ready Content 23, Merged Content Stream 41, and Multi-Media Program 42. This Figure illustrates the use of a Distribution Network 120 to transport these content types to the three Object Insertion Points, Central 91, Regional 92, and Local 93, with ultimate delivery of the Multi-Media Program 42 (which has all of the Multi-Media Object Locations 21 filled with Objects 32) to Recipients 97-99. The Distribution Network 120 is any medium used to convey information, whether wire-line based or wireless or, as described below, physical transportation of removable media. The concepts described herein are not limited to any specific type of distribution network implementation.

Communication paths 61, 62, and 63 each are capable of conveying all three content types Object-Ready Content 23, Merged Content Stream 41, and Multi-Media Program 42 received from Distribution Network 120. Depending on where Object 32 is being inserted into the content determines what content type is conveyed across paths 61, 62, and 63. For example, if the object insertion is exclusively performed at the Central Object Insertion Point 91 (where Regional Object Insertion Point 92 and Local Object Insertion Point 93 are not used), the recipient is 97 and all of the Objects 32 inserted into the Multi-Media Object Locations 21 are common to all Recipients 97. Therefore, the Object-Ready Content 23 is transmitted via Distribution Network 120 and path 61 to the Central Object Insertion Point 91 where the Multi-Media Object Locations 21 are all populated with selected Objects 32.

Alternatively, if the Recipients 98 are served by Regional Object Insertion Point 92, some of the content could have Objects 32 which are inserted at the Central Object Insertion Point 92 (in this example, 70% of the Objects 32 were from the Central Object Insertion Point 91), and the remainder are regionally inserted (30% of the Objects 32 in this example are from Regional Object Insertion Point 92). Alternatively, all of the Objects 32 can be inserted at the Regional Object Insertion Point 92, where the Object-Ready Content 23 is transmitted via Distribution Network 120 and path 62 to the Regional Object Insertion Point 92 where the Multi-Media Object Locations 21 are all populated with selected Objects 32.

Finally, the Recipient 99 could be served by Local Object Insertion Point 93. In this example, some of the pre-inserted objects from Central Object Insertion Point 91 have been replaced or reinserted as have some of the pre-inserted Objects 32 from Regional Object Insertion Point 92—this replacement or reinsertion was done at Local Object Insertion Point 93; this example shows an Object 32 origination source of 60% central, 25% regional, and 15% local for the aggregate Object 32 percentages for the Multi-Media Program 42 delivered to Recipient 99. Thus, the Multi-Media Program 42 can be distributed from the Central Object Insertion Point (for example) with 100% of the Multi-Media Object Locations 21 populated by selected Objects 32, with some of these selected Objects 32 representing “default” Objects 32 that are used to populate the selected Multi-Media Object Locations 21, but subject to being replaced “downstream” by Objects 32 of regional or local interest at the Regional Object Insertion Point 92 and the Local Object Insertion Point 92, respectively.

It is obvious that other architectures are possible—pure central, pure regional, pure local, and any hybrids of the three to deliver content to recipients 97, 98, and 99. For example, Central Object Insertion Point 91 and Local Object Insertion Point 93 architecture would use paths 61 via Central Object Insertion Point 91 via path 71 to Local Object Insertion Point 93 together with path 63 to Local Object Insertion Point 93. In this example, Regional Object Insertion Point 92 is not being used. Another scheme could involve path 62 to Regional Object Insertion Point 92 followed by path 82 to path 73 to Local Object Insertion Point 93 together with path 63 to Local Object Insertion Point 93. In this example Central Object Insertion Point 91 is not being used.

Other combinations are possible with the percentage of objects by insertion location varying on a dynamic basis. Another architecture could have a pure Central Object Insertion Point 91 (100% of the Objects are either inserted in advance at Merged Content Stream 41 or Multi-Media Program 42, or Central Object Insertion Point 91 inserts Objects 32 into Object-Ready Content 23) (or some combination thereof) with a hybrid Regional Object Insertion Point 92 having some objects coming from Central Object Insertion Point 91 with a pure Local Object Insertion Point 93 directly connected to sources 23, 41, and 42 in some dynamic fashion.

### Overall System Architecture—Centralized and Regional

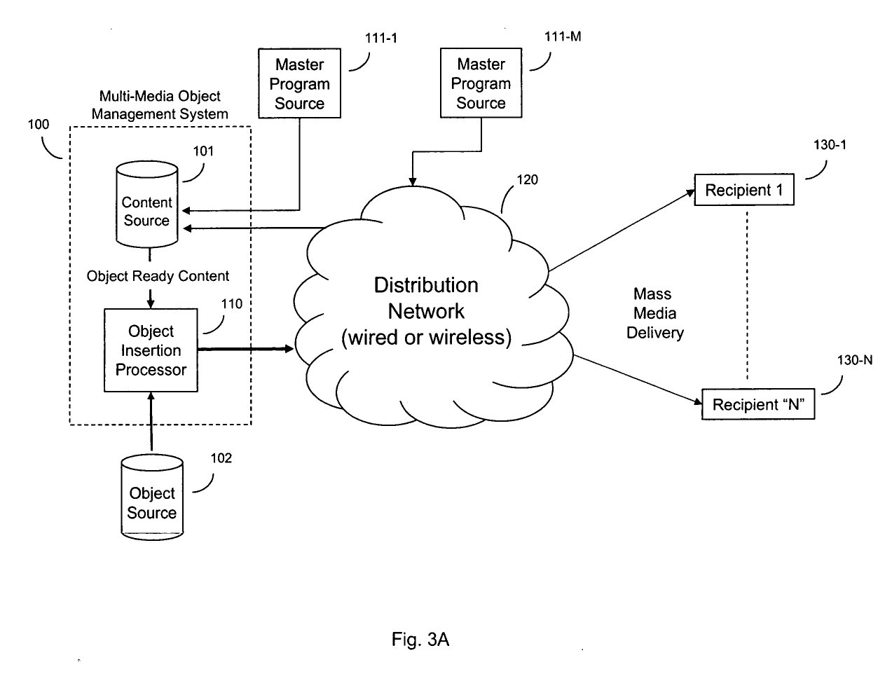

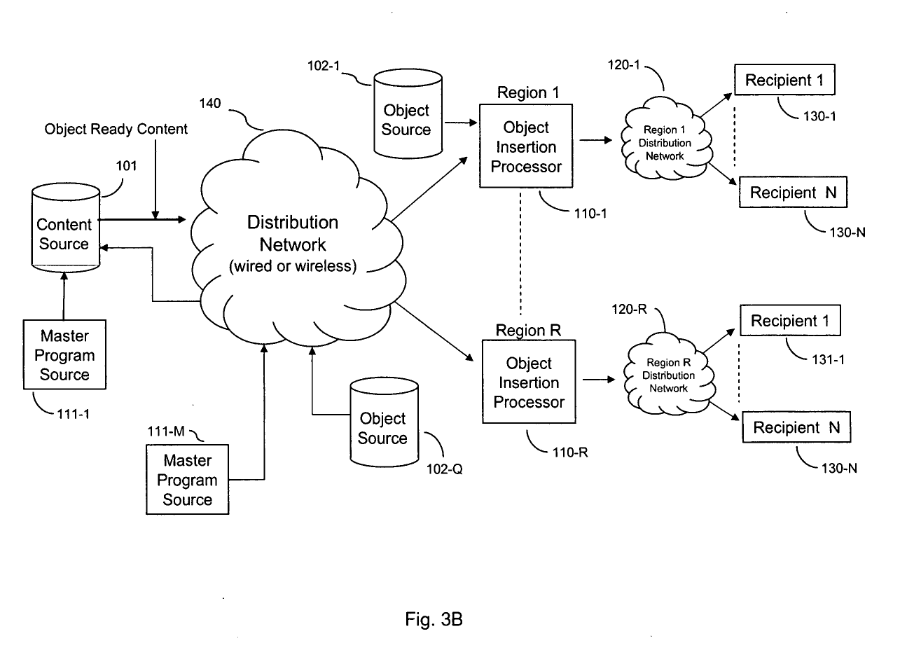

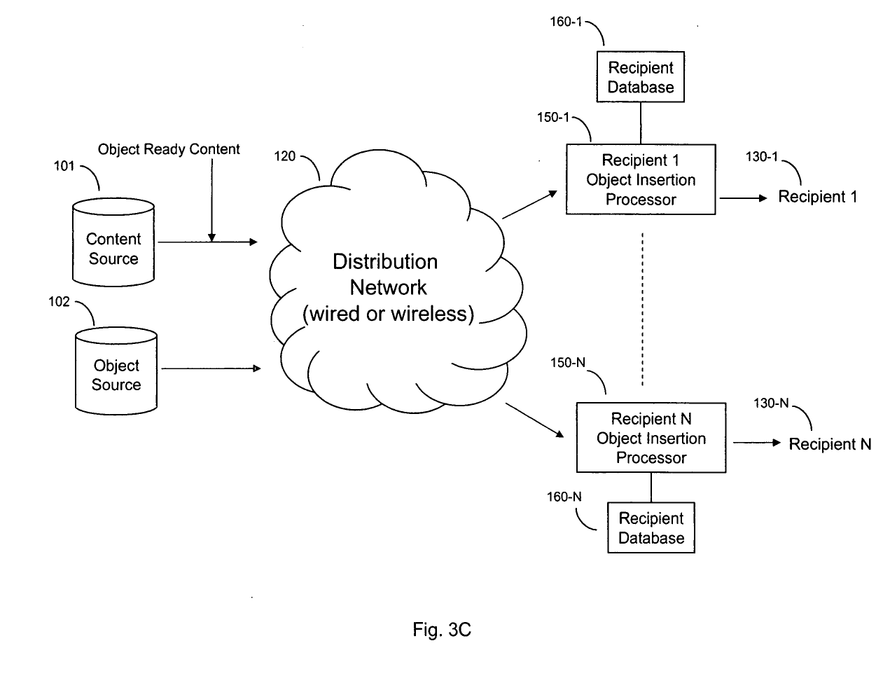

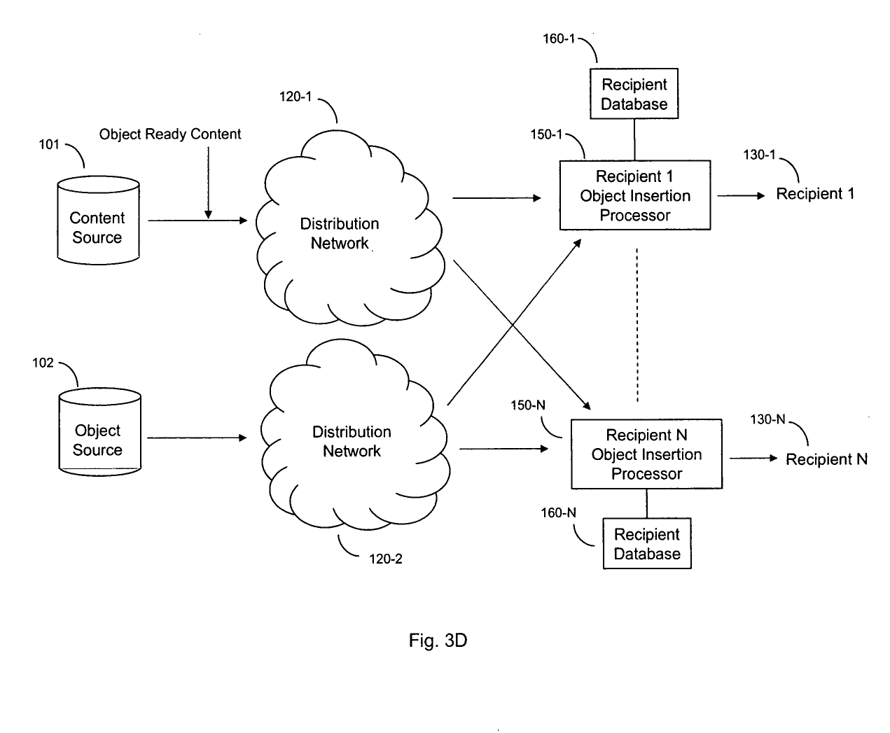

FIG. 3A illustrates, in block diagram form, the overall architecture of the multi-media object management system using a centralized Object insertion paradigm The multi-media object management system functions as a Centralized Object Insertion Site 100 and is architected for a mass market or mass media audience where the recipients, 130-1 to 130-N, (Recipient 1 to Recipient N, respectively share a common demographic profile or are believed to be receptive to the message conveyed, or the Object 32 that is to be inserted by this process is of sufficient general interest to be delivered to all of the recipients, without distinction.

The Object 32 is inserted into the Multi-Media Program 42 at the Centralized Object Insertion Site 100 before delivery of the Multi-Media Program 42 across a Distribution Network 120 where all recipients 130-1 to 130-N observe or experience the same inserted Object 32. With centralized insertion, the object management technology resides at a central location, Centralized Object Insertion Site 100, with Objects 32 stored in an Object Source 102 and Object-Ready Content 23 stored as data files in a Content Source 101. The Object-Ready Content 23 that is stored in Content Source 101 can be generated in its entirety at the Centralized Object Insertion Site 100, or produced by manipulating Master Program 11 that is received directly from Master Program Source 111-1 or received via Distribution Network 120 from Master Program Source 111-M.

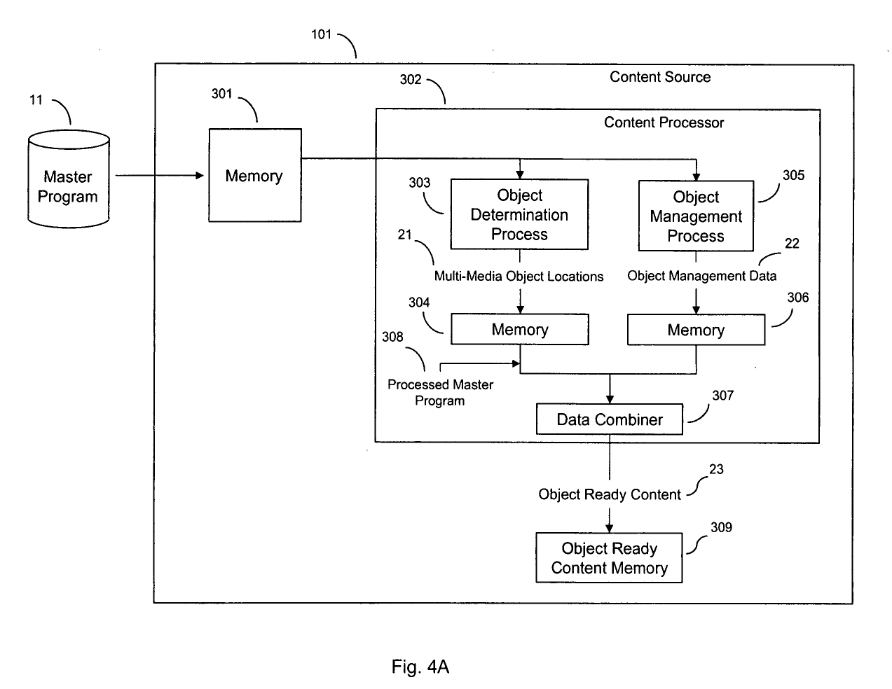

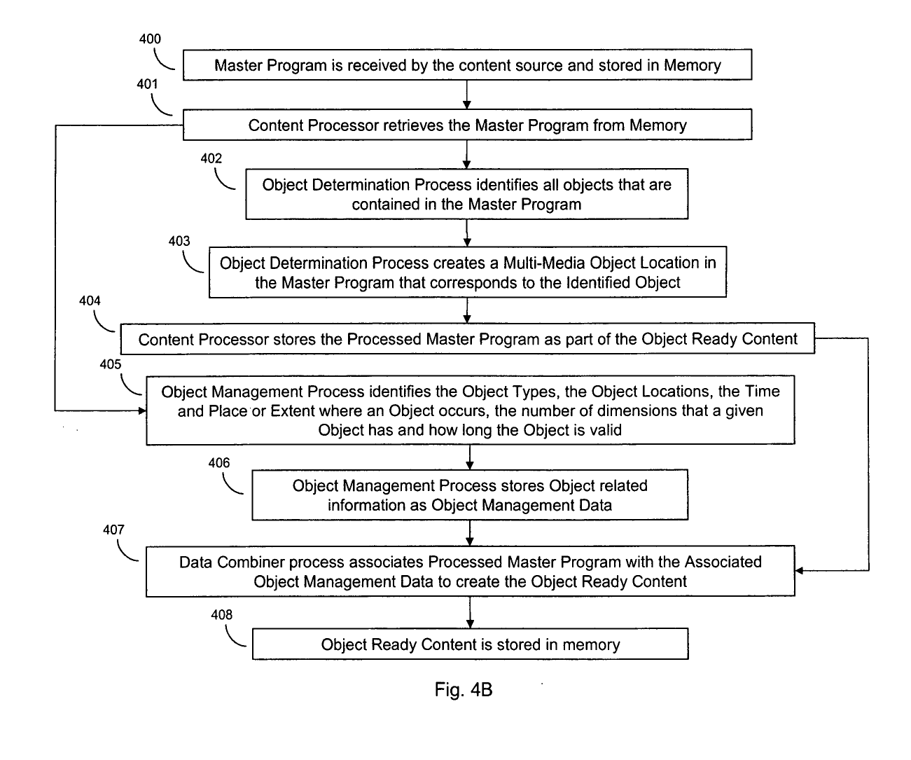

The content stored in the Content Source 101 contains graphical, visual, and aural information plus Object centric information, such as the Object type, the Object location, the time and place or extent in the Multi-Media Program 42 where an Object 32 occurs, the number of dimensions that a given Object 32 has (video and audio or just video, for example) and how long an Object 32 “lives”. This is described below in more detail with respect to the Content Source description of FIGS. 4A and 4B. Both Objects 32 and Object-Ready Content 23 are retrieved from their respective repositories 102, 101 by the Object Insertion Processor 110 and merged into a single data stream for delivery across a Distribution Network 120 to all recipients 130-1 to 130-N. The deployment cost of a centralized system is less than other architectures since it doesn't have to replicate the Content Source 101, the Object Insertion Processor 110 and the Object Source 102.

FIG. 3B illustrates, in block diagram form, the overall architecture of the multi-media object management system using a Regional Object Insertion paradigm. Regional Object Insertion involves “sliding” downstream (closer to the recipient) where the Objects 32 are inserted into the selected Multi-Media Object Locations 21 in the Merged Content Stream 41. The Content Source 101 can remain centrally located. Other variations could have the Content Source 101 being replicated on a regional basis if the content needs to change based on regional demographics. Likewise, the word “region” could be replaced with the words “like interest” or “common demographic” which would then form an N×M matrix of possible Object 32 insertions for a given locale. More likely however, the Recipient Location Object Insertion, as described herein, would be the preferred paradigm versus forming an N×M matrix of the Regional approach. Therefore, the multi-media object management system is implemented in a distributed manner, rather than the elements that comprise this system being co-located.

In the Regional architecture illustrated in FIG. 3B, the Content Source 101 is centrally located. The Object-Ready Content 23 that is stored in Content Source 101 can be produced by manipulating Master Program 11 that is received directly from Master Program Source 111-1 or received via Distribution Network 140 from Master Program Source 111-M This Object-Ready Content 23 is distributed via a Distribution Network 140 to regionally located Object Insertion Processors 110-1 to 110-P, where locally proximate or network connected Object Source databases 102-1 to 102-Q, respectively, are fed into Object Insertion Processors 111-1 to 110-P. The Object-Ready Content 23 can contain logical information describing which Object 32 should be inserted at what point in the content stream on a region-by-region basis (or a demographic-by-demographic basis as an alternative). Alternatively, this decision can be made at the Object Insertion Processor 110-1 to 110-P based on data received via an alternative path. Objects 32 are multi-dimensional and can have the form of visual and aural information integration (an example would be a motorcycle which has a unique sound, i.e., Yamaha versus Harley Davidson). Objects 32 could also have the multidimensional attributes of smell, taste, and touch (you smell the burning rubber of the tires, you taste the fine liquor, or you feel the vibration of an earthquake all being Object Characteristic Data 31). Ultimately, Object-Ready Content 23 with regionally targeted Objects 32 are delivered via respective networks 120-1 to 120-R to Recipients 130-1 through 130-N and 131-1 through 131-N for that respective region.

### Content Source

FIG. 4A illustrates, in block diagram form, the overall architecture of a typical content source system 101, and FIG. 4B illustrates, in flow diagram form, the operation of a typical content source system 101. The Master Program 11 is stored in Memory 301 and then processed as described herein to produce the Object-Ready Content 23. The processing of Master Program 11 is described herein to illustrate the process of creating Multi-Media Object Locations 21 and managing these for the insertion of Objects 32 into the Object-Ready Content 23.

The Content Source algorithm contains a number of key building blocks which create Object-Ready Content 23. Master Program 11 is content that is not Object ready. It becomes Object-Ready Content 23 after the identification of all Multi-Media Object Locations 21, wherein a Multi-Media Object Location 21 is created in the Master Program 11 and corresponding Object Management Data 22 which comprises Object centric information, such as the Object type, the Object location, the time and place or extent in the Multi-Media Program where an Object occurs, the number of dimensions that a given Object has (video and audio or just video, for example) and how long an Object “lives”.

At step 400 (FIG. 4B), the Master Program 11 is received by the Content Source 101 and stored in Memory 301. The Content Processor 302 retrieves the Master Program 11 from Memory 301 at step 401 and identifies all Multi-Media Object Locations 21 that are contained in the Master Program 11 at step 402, using an Object Determination Process 303. This can be done automatically, such as by using props (cans, cars, chroma-key, etc.) in the creation of the Master Program 11 that are automatically identifiable by the Content Processor 302 via certain unique characteristics of the props that make them distinguishable from non-Objects in the Master Program 11. The Content Processor 302 then creates a Multi-Media Object Location 21 in the Master Program 11 at step 403 that corresponds to the identified Object 32 and then stores the processed Master Program 308 in Memory 304 at step 404.

Along a parallel algorithmic path, the Object Management Process 305 uses the retrieved Master Program 11 and identifies at step 405 the Object types, the Object location, the time and place or extent where an Object 32 occurs, the number of dimensions that a given Object 32 has (video and audio or just video, for example) and how long an Object 32 “lives”. For example, a movie that is broadcast in 2008 and then again in 2010 quite likely has different Objects 32 being used. The Object Management Process 305 at step 406 stores this Multi-Media Object Location-related information as Object Management Data 22 in Memory 306. The Object Management Data 22 contains all of the afore-mentioned Object attributes and is used to convey this information downstream to the Object Insertion Processor 110.

The Data Combiner Process 307 combines the Processed Master Program 308 with the associated Object Management Data 22 at step 407 to create the Object-Ready Content 23 which is stored in Object-Ready Content Memory 309 at step 408.

The above-mentioned steps 404, 406 of storing file data maybe unnecessary if the Data Combiner Process 307 processes the generated data in real time, and writes the resultant Object-Ready Content 23 to Object-Ready Content Memory 309. Likewise, ultra-fast processing and delivery methods may not require Object-Ready Content Memory—in this case, the Processed Master Program could be streamed “live” to the Object Insertion Processor, wherever it is located—this architecture modification is likely for a “live” content program such as a sporting event.

### Object Characteristics

Each Object 32 has a plurality of characteristics that define the owner of the Object 32, the rendering of the Object 32 in a program (static, adaptable, dynamic), the content of the Object 32 (product identification and limitations on its use), as well as other data that are appropriate for the management of the Object 32 in the Multi-Media Program 42 context. Object Characteristics Data 31 includes the set of data that defines the content of an associated Object 32, including the class of Object, identification of the owner of the Object, and limitations (if any) on the use of the Object. The characteristics or attributes of an Object can be uni-dimensional or multi-dimensional and can include but are not limited to: video (moving images), still images, audio, audio that is matched with a given Object, other senses such as feel-smell-taste, and the like. An Object such as a cup of coffee could have a brand logo, an image and an aroma. A typical Object Characteristic would be two-dimensional having an image and an associated sound clip.

### Multi-Media Object Location

Like the Object 32 having ownership, Multi-Media Object Location 21 has an owner associated with it as well, albeit different than Object 32 ownership. However, when comparing the ownership of the Object 32 versus the Multi-Media Object Location 21, the Object 32 is often a branded or trademarked product or service owned by a given company where the company has absolute ownership of all rights associated with its Object 32, while the “ownership” of the Multi-Media Object Location 21 is most often retained by the owner of the Multi-Media Program 42. From the advertiser's perspective, the use of Multi-Media Object Location 21 is generally transient and takes the form of a lease (although it is possible for a company to purchase Multi-Media Object Location 21 rights in perpetuity albeit said lease rights being substantially more expensive than the transient right). The transient lease rights of a Multi-Media Object Location 21 can be one-time-only, multiple play, just-in-time (rights auction just before real time delivery to the Recipient) and so on.

### Multi-Media Object Insertion—Identical Characteristics And Matched Class

In the case where a selected Object 32 is identical in its “footprint” with the Multi-Media Object Location 23 defined in the Multi-Media Program 42, the Object insertion process is a simple substitution. Thus, a standard size soda can is fungible, and the only delimiting factor is the label applied to the standard size soda can to identify the contents and the company that has produced this product. The selected Object must also be reviewed to determine whether the content of the Object is appropriate for the selected placement in the program. Thus, a can of motor oil would be an inappropriate selection to be displayed on the kitchen counter of a cooking show in place of a can of tomatoes.

### Multi-Media Object Insertion—Different Characteristics and Matched Class

In the case where a selected Object 32 is not identical in its “footprint” with the Multi-Media Object Location 23 defined in the Multi-Media Program 42, the Object insertion process is more complex than a simple Object 32 substitution. In this case, the selected Object 32, together with the background layer of multimedia content juxtaposed to the Multi-Media Object Location 21, optimally needs to have the background multi-media layer morph (and foreground morph, if necessary), modify, or adjust its shape to match the new shape, size, and motion of the Multi-Media Object Location 21 so that the new Object 32 is now contiguous in its placement into the Master Program 11. It is also possible to morph, modify, or adjust the shape and size of the Object 32, but this is disadvantageous since most Objects 32 have identifiable shapes, colors, sizes, etc., that confer brand recognition; thus, morphing the Object 32 could impair the value of the dynamically placed in situ Object 32 (product placement). This is particularly true for an Object 32 in motion likewise for a Multi-Media Object Location 21 that is in motion). The preferred embodiment is to morph, modify, or adjust the background (or foreground) in synchronization with the Multi-Media Object Location 21 versus doing a likewise process on the Object 32. It is most desirable to match the new Object 32 with a new Multi-Media Object Location 21 so that these two elements are identical in shape (if a visual representation) with only the background (foreground) changing. Finally, if an Object 32 has two dimensions, video and audio, the Object's audio would be mixed with the Master Program audio to create a seamless audio stream for the life of the Object 32.

### Multi-Media Object Insertion—Interactivity with Surroundings in a Multi-Media Program

In the case where the selected Object 32 is not identical in its footprint but also either interacts with surrounding visualizations or must be interfaced with surrounding subjects in the program, the Object insertion process requires manipulation of the selected Multi-Media Object Location 21 and the Master Program 11 background juxtaposed to the Multi-Media Object Location 21 to ensure the nature of the selected Object 32 is not changed, and the juxtaposed surroundings are naturally morphed, modified, or adjusted to ensure the interface between the selected Object 32 and the juxtaposed multi-media background or interrelated visualizations are harmonious in a seamless fashion. Thus, where a hand is holding a beverage container and the selected Object 32 provides a rendering of a beverage container of different shape, the hand must be modified so the hand with the beverage container of the selected Object 32 appears natural. This can be done by electronically inserting a “new hand with the proper finger locations” or it could be done by shooting a short clip new scene and then digitally inserting that new scene when the new Object 32 with a beverage container handle is used. Thus, the director and producer of the Master Program, to include the writers or authors of the Master Program, could anticipate in advance the likely set of possible Object 32 shapes that would be used in the finished product Multi-Media Program 42, and where necessary, create additional movie segments (video and audio) that accommodate all the likely Object 32 shapes and motions.

FIG. 8A shows the creation of a Multi-Media Object Location 21 in the upper left hand corner which is in the shape of a bottle. The man consuming the beverage identified by this Multi-Media Object Location 21 is shown as a static image (non-changing); however, the invention does not limit the concept to embody this being a single frame or field of a movie or television program. In fact, the preceding and subsequent frames would likely have the Multi-Media Object Location 21 in motion. Continuing with the description of FIG. 8A, sub-FIG. 8B shows the insertion of Object 32 which in this picture is a bottle of Coke. FIG. 8C depicts the man drinking a bottle of Gallo® wine, while FIG. 8D has a Heineken® bottle of beer inserted. Based on the interests of the Recipient, the Object 32 insertion is customized for the interests of that Recipient (or customized for the interests of an advertiser who wishes to “steal” market share from a competitor by capturing those recipients who may be on the fence concerning switching to a different product).

### System Architecture—Localized Object Insertion

FIGS. 3C and 3D illustrate, in block diagram form, two overall architectures of the multi-media object management system using a localized recipient-based Object insertion paradigm. Recipient Location Object Insertion has the finest granularity and accuracy of Object delivery based on the profile of a given Recipient. This architecture is also the most expensive to replicate, since the Object insertion technology must reside at every recipient's location, whether it is a cell phone, a PDA, an HDTV, a radio, or an iPod. It is also conceivable that the composite architecture of a given system could involve elements of the central scheme, the regional scheme, and the local scheme.

Emerging video or television architectures that use IPTV (Internet Protocol Television) are also a form of local delivery and could be delivered to a personal computer or to an IPTV set-top box. One advantage that IPTV has is that the Recipient Database (shown in FIG. 1 as 33 and also in FIG. 3C as 160-1) is generally available (physical location, what person is using which device, demographics, psychographics, sociographics, viewing habits, and so on).

If the device is a mobile one, such as a cell phone enabled for video reception in some manner, GPS location as well as the subscriber database is stored in database registers such as HLRs (Home Location Registers) and VLRs (Visitor Location Registers). Thus, in the mobile context, Recipient Database 33 information is inherently and automatically available enabling optimal Object selection and insertion. In this mobile example, the Recipient Database 160-1 in FIG. 3C (in cellular an HLR or VLR) feeds this Recipient information into the Object Insertion Processor 150-1 (also FIG. 3Q) to optimize Object 32 insertion into the video being watched by a mobile handheld device subscriber.

The localized recipient object insertion architecture truly matches Objects 32 with Recipient's interests, needs, and desires contained in Recipient Database 33. In this context, the advertiser has made an optimal connection with the recipient for a given product or service which is imbedded into the content stream. Break and Make advertising is no longer required and a 30-minute Multi-Media Program is truly 30 minutes of entertainment. In the era of e-books or e-readers, the Recipient downloads a magazine and has electronic advertising that is directly paired with that Recipient's interests. Object 32 definition could even include, for example, the favorite color of the Recipient (say for an advertised car the Recipient is interested in). For all of these architectures, but in particular for the Local Insertion which is highly customized, a third database, shown in FIGS. 3C and 3D, the Recipient Database 160-1 to 160-P, stores the demographic, psychographic, and sociographic profile of all recipients. This Recipient Database 160-1 to 160-P is constantly evolving, ever matching the changing desires and needs and wants of the Recipient. For instance, if the Recipient gets married and has children, Objects may need to be more family oriented. As the Recipient becomes an empty nester, Objects may become more travel oriented, for example, with life experiences being a central focus.

In FIGS. 3C and 3D, Objects are stored in an Object Source 102 and Object-Ready Content 23 is stored as data files in a Content Source 101. The content stored in the Content Source 101 contains graphical, visual, and aural information plus Object centric information. Both Objects 32 and content are retrieved from their respective repositories 102, 101 and transmitted via Distribution Network 120 in FIG. 3C and across networks 140 and 141 in FIG. 3D via Distribution Networks 120-1, 120-2 to a plurality of Object Insertion Processors 150-1 to 150-N, which are located proximate to the Recipients 130-1 to 130-N. The Object-Ready Content and the Objects are merged into a single data stream by the Object Insertion Processors 150-1 to 150-N. The deployment cost of a localized system is greater than other architectures since it replicates the Object Insertion Processors 150-1 to 150-N and also maintains one or more Recipient Databases 160-1 to 160-N.

FIG. 3D illustrates the case where the Object Source 102 is served by a network 131 that is different that the Distribution Network 140 that serves the Content Source 101. In fact, there can be multiple content sources and multiple Object 32 sources, served by different or the same networks, such that the Object-Ready Content 23 and the appropriate Objects 32 are retrieved from their repositories, wherever they may reside, by the Object Insertion Processors 150-1 to 150-P and combined therein for the corresponding recipient.

### Object Insertion Processor

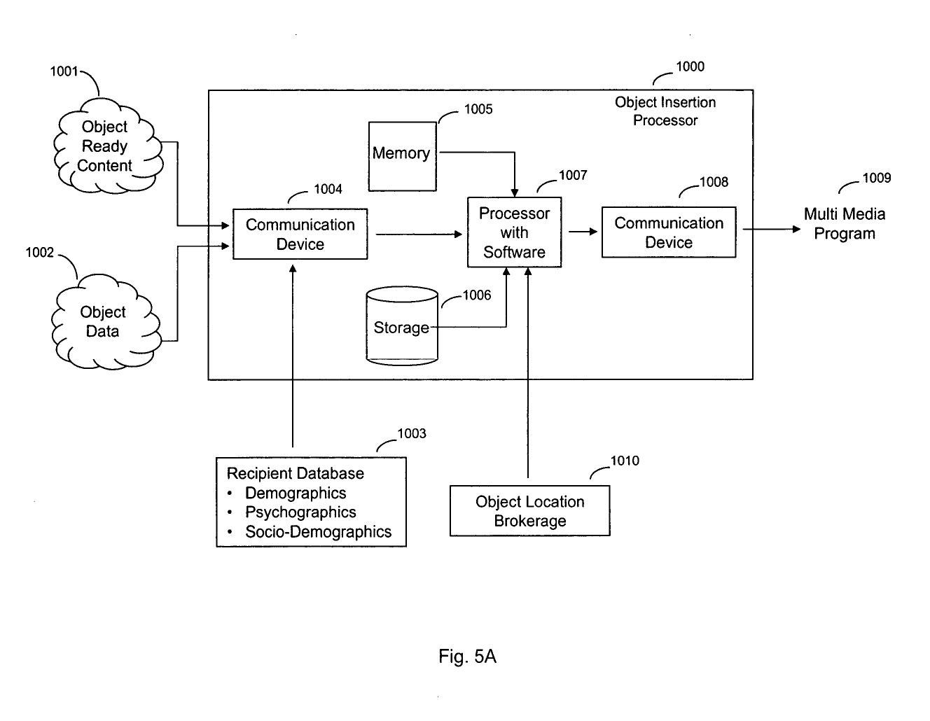

FIG. 5A illustrates, in block diagram form, the overall architecture of a typical Object Insertion Processor; and FIG. 5B illustrates, in flow diagram form, the operation of a typical Object Insertion Processor, on a frame-wise basis in inserting Objects into Multi-Media Object Locations. The Object Insertion Processor 1000 is the hardware-software enabled device which does the Object insertion into a given Object-Ready Content stream. For example, if the Object-Ready Content 23 is a movie, the Object-Ready Content 23 has a plurality of Multi-Media Object Locations 21 in both the audio and video where Objects 32 are to be inserted, as well as Object Management Data 22 that defines the characteristics of the Multi-Media Object Location 21 as noted above. The Object Data 1002 contains the representation of the Object to be inserted at a given location, time, and space in the content data stream as well as Object Characteristic Data 31 that defines the essential attributes of the Object 32.

The Object Insertion Processor 1000 shown in FIG. 5A also receives data from a Recipient Database 1003 (shown also as 33 in FIG. 1) such as demographics and psychographics, socio-profile, and viewing habits for a given Recipient (where the Recipient Database 1003 is ever changing) and pairs that information with the entire Set of Objects to select the “best” Object 32 to be inserted (i.e., a Pepsi drinker isn't interested in seeing a Coke ad, or Coke wishes to steal market share from Pepsi and advertises its Objects to Pepsi drinkers who are on the fence). The output of the Object Insertion Processor 1000 is Multi-Media Program (Customized Object Content) 1009 that is Recipient optimized from an Object 32 insertion paradigm.

Object Insertion Processor 1000 performs additional tasks such as high reliability and high availability communications at devices 1004 and 1008, the input and output nodes, respectively, of Object Insertion Processor 1000. The Object Insertion Processor 1000 has Memory 1005 and Storage 1006 to manage data flow and processing capability in 1007.

More complex, the Object Insertion Processor 1000 performs tasks at 1007 such as morphing a given video frame so that the inserted Object fits fully into the “content hole” (also termed Multi-Media Object Location 21)—this process is essential since an inserted Object 1 to inserted Object N in the matrix of possible Objects available to insert may not have the same exact shape (i.e., a Heineken bottle has a different shape than a Coors bottle). This morphing process continues for every frame until the Object insertion timeframe is completed; and a given frame could have 1 to Y Objects being inserted in a concurrent or simultaneous fashion, with any given frame having its own defined set of Objects being inserted.

For a video data file, the Objects contained therein are generally two dimensional—an image and associated sound clip (to be merged into the composite audio stream). However, there is no limitation on Objects being in only two dimensions. Objects are multi-dimensional (to include visual effects to create a 3-D perspective from the Recipient's viewpoint) and necessarily have attributes associated with those dimensions. Attributes such as feel, smell, taste, and others are readily possible.

The Object Insertion Processor Algorithm starts at step 1100 with the receipt of the Objects 1111 and the Object-Ready Content data 1101. The Object-Ready Content data 1101 is further separated at step 1102 into the Object Management Data 1103 and the processed Master Program 1104. The Objects 1111 are multi-dimensional, and the Object Database of Objects 1111 can contain exactly the exact number of needed Objects or it could contain the entire universe of available Objects 1111 (from which it has to make a selection based on the Recipient Profile Processor 1130 using the Recipient Database 33). The Object is inserted into the content “hole” (or Multi-Media Object Location) at step 1131 as a function of the purchase of the Multi-Media Object Location, as identified by the Object Location Brokerage 1010, in a continuous fashion where step 1132 is a frame or field of a composite video stream (for example) until the content stream is complete as determined at step 1133. The Object Insertion Processor Algorithm process can be done in advance, near real time, real time, or just-in-time. The timing of when an Object 32 and Object 1111 is inserted affects the market value of an Object—for example, if a professional golfer who uses Nike equipment Niger Woods) wins the US Open, Nike would pay a premium to purchase just-in-time Multi-Media Object Locations 21 after Tiger Woods just won the tournament in the live programming television feed in order to showcase their “winning” equipment.

### Object Selection Process

The population of the Multi-Media Object Locations 21 with Objects 32 is controlled not only by the appropriateness of the Object 32 in the Master Program 11 but also by the purchasing of the Multi-Media Object Locations 21 by advertisers to have their products displayed in the Multi-Media Program 42. There are numerous procedures that can be used to effect the purchase and management of the Multi-Media Object Locations 21, and these result in the creation of a set of attribution data that defines the particular Object 32 that is to be used to populate a selected Multi-Media Object Location 21, subject to the Master Program Rule Set 12, the Object Characteristic Data 31, and the Object Management Data 22 confirming the selection.

The Object Insertion Processor (for example, 110 in the Central Architecture 3A) must select an appropriate Object 32 for insertion into a selected Multi-Media Object Location 21 based upon certain parameters that are defined in the Object Management Data 22 and the Object Characteristic Data 31. In addition, the purchasing of selected Multi-Media Object Location 21 by advertisers is a consideration and must be reconciled with the parameters that are defined in the Object Management Data 22 and the Object Characteristic Data 31. For example, the Object Insertion Processor 110 as shown in FIG. 3A determines the nature of the Object 32 from the Object Management Data 22 and thereby can identify a class of Objects 32 from the Object Characteristic Data 31 that would be appropriate to use in populating this selected Multi-Media Object Location 21. The members of this class are than available for selection by advertisers, subject to any associated limitations provided by the Master Program Rule Set 12.

If an Object 32 is determined to violate one of the rules in the Master Program Rule Set 12 or Object Management Data 22, or there is a failure to match Object 32 with the selected Multi-Media Object Location 21 due to the Object Characteristic Data 31 failing to match the Object Management Data 22, the Reconcile Processor 52 includes a process to terminate the Object insertion into the selected Multi-Media Object Location 21. The Reconcile Processor 52 then can generate an error indication to a system operator or can autonomously locate a substitute Object for insertion into the selected Multi-Media Object Location 21 by retrieving either a default Object that is in this class of Object, or an Object that represents the Object that was next highest in the bidding process for this Multi-Media Object Location, or some other Object owned by the same purchaser that is appropriate for the selected Multi-Media Object Location. There are numerous options that can be envisioned for managing this situation, and those mentioned above represent typical responses.

### Object Location Brokerage

The availability of multiple options for the sale of Objects 32 (or product placements) provides a complex, virtual matrix of levels and opportunities for product placement. The multi-media object management system described herein creates promotional solutions at levels heretofore not available to companies, advertisers, and other promotional entities.

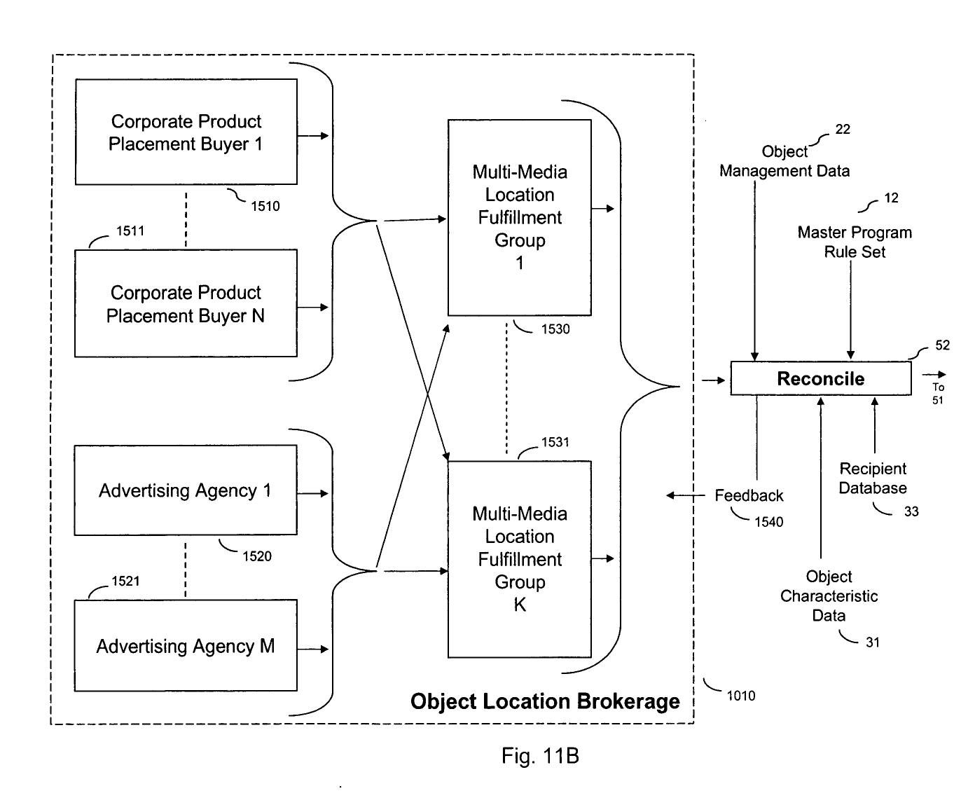

FIG. 11A depicts this complex product placement insertion matrix. The left hand axis, 1410, is the Object Purchase and/or Insertion Timeframe which can be defined as when a Multi-Media Object Location 21 (MMOL) is either purchased (or the right to insert an Object 32 in the selected Multi-Media Object Location 21 is reserved) and/or when the Object 32 is actually inserted in the selected Multi-Media Object Location 21 by the Object Location Processor 1000. The Object Insertion Point, 1400, in a given Master Program 11 to form the Multi-Media Program 42 can be done by geographic means (International 1420 to Personal 1424) as shown in FIG. 11A as the preferred embodiment; alternatively each geographic column could be replaced with demographic, psychographic or sociographic columns to form a new delivery targeting means 1405. It is obvious that any combination of the aforementioned attributes is possible, with no attribute being mutually exclusive of another. Thus, a regional delivery architecture could also embody demographic and psychographic targeting within that given geographic region.

Specific product placement can be as broad and extensive as the entire world or as focused as an individual household. Object Insertion Points 1400 available for consideration when placing a specific object purchase are International 1420, National 1421, Regional 1422, Local 1423, and Personal 1424 Object Insertion Points. Within each level, multiple opportunities exist for focusing product placement on as large or as small a scale as is sought.

To further define each level:
An International Object Insertion Point 1420 placement could involve multiple countries at the same time;
A National Object Insertion Point 1421 placement necessarily would involve purchasing a position or positions dispersed over an entire country,
A Regional Object Insertion Point 1422 placement might include a state or several states, such as the Midwestern US or Pacific Northwest region;
A Local Object Insertion Point 1423 placement basically comes down to a specific city or small region; and
A Personal Object Insertion Point 1424 placement can be determined at each individual household or set-top box level. It is possible to have neighboring households receiving different product placements depending on the psychographic desires of each household.

Each product placement has a default cost or price level for every delivery stage. At the right level, the default cost carries through to all markets; however, a bidding process is in place that allows the default price to be overridden under certain circumstances by other more targeted or localized products further downstream in the decision process.

The process involves a bidding system with multiple levels and opportunities that includes:
A Packaged or Pre-Packaged 1411 set of options for object placement is the highest decision level for inserting an object for the largest possible exposure and could involve both override and non-override options at several pricing levels. At this level decisions can be made to “lock-in” a specific number of placements, or place the product in a “default” mode where price and exposure depends on other decisions further down line involving higher placement and pricing levels.
A Non-Real Time 1412 object placement involves purchasing a position for a product after the pre-packaged options have been exhausted but while a show is being streamed to its destination. This placement could happen as a second level purchase at any stage of the delivery process prior to the program being viewed.
A “Real” Time 1413 object placement is a third level decision that comes at a point just prior to a program being viewed (just-in-time). This decision process can happen further down line (closer to the recipient) and is dependent on a decision to override certain product placement decisions where the option is made available to insert substitute products that may be more regional or local or personal in nature. In the overall bidding process for insertion, Personal 1424 can supplant Local 1423, which in turn could previously have supplanted Regional 1422 for a given Multi-Media Object Location insertion point. This paradigm maximizes Multi-Media Object Location value as well as optimizes Object 32 to Recipient matching.

FIG. 11A is a preferred embodiment 30-minute Multi-Media Program (television show) with Multi-Media Object Locations each having spatial and temporal extent in the Multi-Media Program where Multi-Media Object Locations further have Object Insertion Point 1400 and Purchase and/or Insertion Timeframe 1410 attributes. This example 30-minute commercial-break-free television program comprises in situ product placement involving one hundred (100 each) Multi-Media Object Locations 21 filled with Objects 32 from Corporate Product Placement Buyers 1 to N (FIG. 11B, elements 1510 to 1511) and Advertising Agencies 1 to M (FIG. 11B, elements 1520 to 1521) throughout the 30-minute Multi-Media Program 42.

In FIG. 11A, the targeted recipients are primarily in a single country with a slight overlap to a neighboring country. Thus, the number of International 1420 Multi-Media Object Locations 21 reserved and purchased is small in quantity. In this International 1420 case, Multi-Media Object Location 21 insertion points 1, 3, and 4 are being inserted for International 1430 delivery. These International Multi-Media Object Locations 21 are Pre-Packaged 1411, meaning they were purchased in advance and inserted far upstream from the recipient's location. At the National 1421 level, both Pre-Packaged 1411 and Non-Real Time 1412 use Multi-Media Object Location 21 insertion points of 10-20 (figure element 1440) and 6-9 (figure element 1441), respectively. At the Regional 1422 level, Pre-Packaged 1411, Non-Real Time 1412, and “Real” Time 1413 are all used for product placement (object insertion) for Multi-Media Object Locations 51-60 (figure element 1450), Multi-Media Object Location 21-30 (figure element 1451), and Multi-Media Object Locations 31-38 (figure element 1452), respectively. At the Local 1423 level, Pre-Packaged 1411 is not used in this embodiment. Rather, Local 1423 embodies Non-Real Time 1412 with Multi-Media Object Location 21 insertion points 61-73 (figure element 1461) and “Real” Time 1413 with Multi-Media Object Location 21 insertion points 83-69 (figure element 1462). Finally, at the Personal 1424 insertion location, Multi-Media Object Locations 90-100 (figure element 1471) uses Non-Real Time 1412, and Multi-Media Object Locations 2, 5, 39-50, 74-82 (FIG. 11A element 1472) uses “Real” Time 1413 purchase and/or insertions timeframes.

FIG. 11B describes the Object Location Brokerage 1010 as a buying matrix wherein Buyers of Multi-Media Object Locations 21 are Corporate Product Placement Buyer 1 to N (1510 to 1511, respectively) and Advertising Agency 1 to M (1520 to 1521), which are paired via a purchasing network, verbal/computer/other, to Multi-Media Location Fulfillment Groups 1 to K (1530 to 1531, respectively). The Multi-Media Fulfillment Groups comprise a diverse set of entities: Master Program 11 owner, Multi-Media Program 42 owner, a cable television company, a satellite television company, a cellular radio company, a radio (audio) company, an Internet company and the like. In addition, the Multi-Media Fulfillment Group could even be a specialist wherein their only business purpose is to pair-up or sell Multi-Media Object Locations 21 that are available in a given content stream. In addition, the preferred embodiment shown in FIG. 11B does not preclude the Corporate Product Placement Buyer (1510 and 1511) from connecting directly to the Reconcile Processor 52, bypassing the Multi-Media Location Fulfillment Group, thereby increasing the economic efficiencies of the Multi-Media Object Location insertion transaction. It is anticipated that only very large purchasers of Multi-Media Object Locations 21 would be granted direct access.

The Reconcile Processor 52 manages a diverse set of inputs: Object Management Data 22, Master Program Rule Set 12, Recipient Database 33, Object Characteristic Data 31, and the Object Location Brokerage 1010. While the process flow arrow out of the Object Location Brokerage 1010 is generally into Reconcile Processor 52, the actual operation involves a bi-directional exchange of information. For instance, after a Multi-Media Object Location 21 is used and has expired, the Object Management Data 22 would communicate the expiration to the Object Location Brokerage 1010 so that it knows it can re-sell that Multi-Media Object Location 21. Similarly, the Object Location Brokerage 1010 needs to know the characteristics of Recipients 33, Object Characteristic Database 31, and Master Program Rule Set 12 in order to optimize the matching of a Multi-Media Object Location 21 at a particular Object insertion point with Buyers and their associated Objects 32. The Recipient Database 33 contains various information about the Recipient(s), such as viewing habits, and can be used to weight the decision for Object selection to the Object most of interest to the Recipient(s). Thus, the selection of an Object from a number of possible Objects is influenced by the receptiveness of the Recipients who receive the Multi-Media Program Not only does this maximize Object 32 targeting but it also maximizes revenue and income opportunities across the entire Multi-Media Object Management System. This “feedback” is shown as a labeled arrow 1540 going down and then back into the Object Location Brokerage 1010 in its entirety as all sub-elements of Object Location Brokerage 1010 need this feedback to function—Multi-Media Location Fulfillment Groups (1530 & 1531), Advertising Agencies (1520 & 1521), and Corporate Product Placement Buyers (1510 & 1511). Thus, the effectiveness of the advertising can be gauged by the “votes” placed by the Recipients in terms of the Recipient profile data contained in the Recipient Database 33 or even active feedback provided by the Recipients.

In addition, this “feedback” loop provides confirmation to the Fulfillment Group and the Buyer that the Multi-Media Object Location 21 insertion was successfully placed with a given designated Object 32 and that payment for said confirmation can then be initiated by Buyer to the Fulfillment Group (if not already pre-purchased). If pre-paid and the Multi-Media Object Location 21 insertion was not successful, a “make-good” Multi-Media Object Location 21 insertion can be scheduled.

The Reconcile Processor has authorization and authentication means to insure the Objects are genuine, that the Multi-Media Object Location was purchased either directly or through a Fulfillment Group, has been paid for, and that the Buyer is genuine and authorized to process a Multi-Media Object Location insertion. The Reconcile Processor 52 outputs its processed data to the Object Insertion Processor 1000 (or step 51 in FIG. 1).

### Digital Rights Management

In the multi-media object management system, the issue of digital rights management arises, since it is commercially important to prevent the substitution of one Object for another once that initial Object has been inserted into its assigned Multi-Media Object Location. The exception is where the initial object placement is conditional, as described above with respect to the Object Location Brokerage. Therefore, the population of Objects 32 in the Multi-Media Program 42 must result in a process that secures the population of the Multi-Media Object Location 21. This can be effected by expunging the Object Management Data 22 associated with a selected Multi-Media Object Location 21 once this Multi-Media Object Location 21 is populated with an Object 32. The insertion of an Object 32 into a selected Multi-Media Object Location 21 and the associated removal of the corresponding Object Management Data from the Object-Ready Content 23 (or the Merged Content Stream 41) renders the presence of the Object transparent, since it is now an integral part of the Multi-Media Program 42, and the Multi-Media Object Location 21 is no longer evident. This process secures the Multi-Media Object Locations 21 once they are populated with Objects 32 so that the digital rights to that insertion are safeguarded.

Alternatively, the Object Management Data can remain in the Object-Ready Content 23 and/or the Merged Content Media Stream 41 and other security mechanisms used to prevent (or manage) the substitution of one Object for another, once that initial Object has been inserted into its assigned Multi-Media Object Location. In particular, there are numerous security paradigms in use to prevent the access to selected data absent proper authorization and authentication. In the case of conditional reservation of a selected Multi-Media Object Location 21, the process includes the Object Insertion Processor 110 comparing the Object Management Data, which would now include data regarding the initial purchaser and their terms of purchase, to the request to purchase the selected Multi-Media Object Location 21 received from a subsequent purchaser. If the subsequent purchaser satisfies the rule set that defines allowable substitution, the original Object is expunged from the selected Multi-Media Object Location 21 and the Object 32 owner (or brokered) by the subsequent purchaser is used to populate the selected Multi-Media Object Location 21.

### System For Profiling the Interests of Recipients in a Cable Television Network

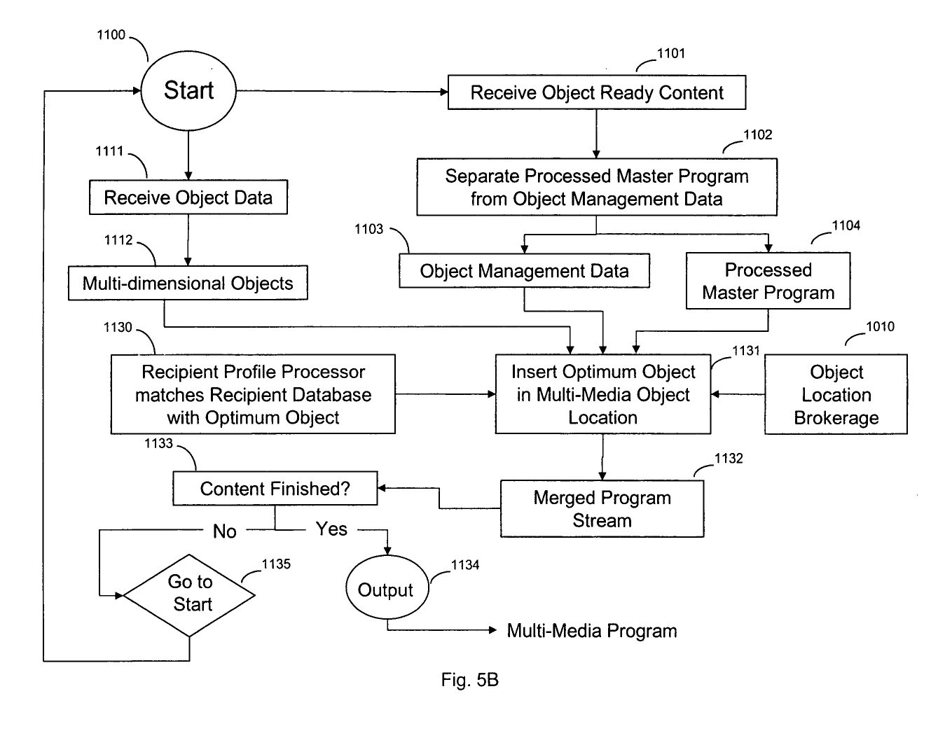

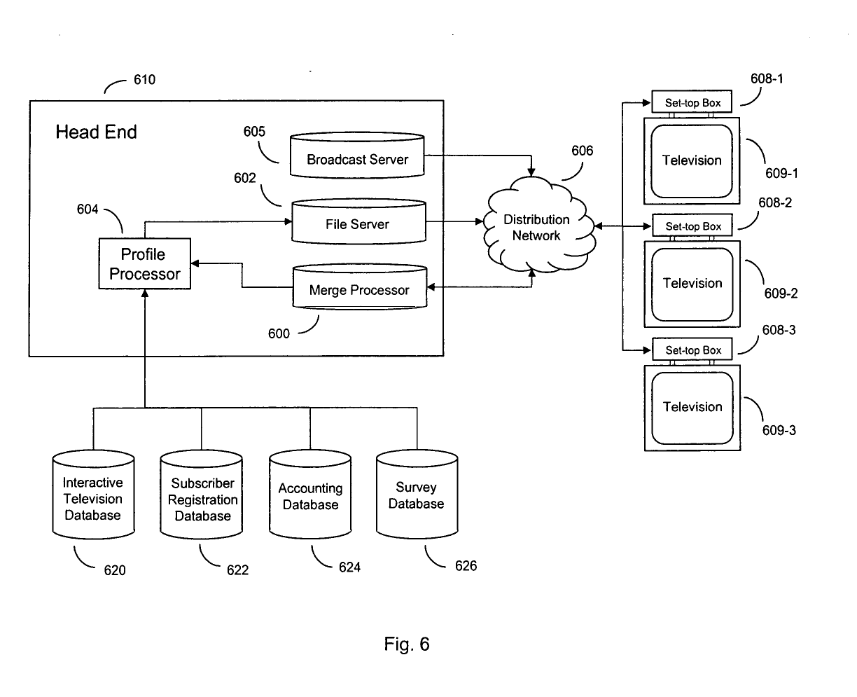

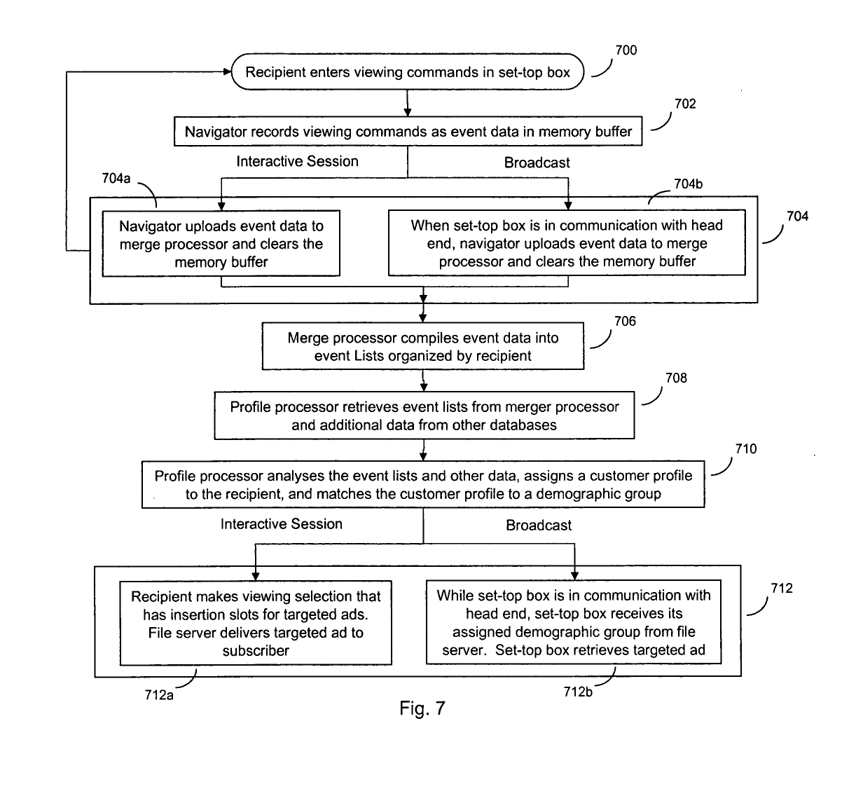

FIG. 6 illustrates, in block diagram form, a typical system for profiling the interests of recipients in a cable television network (termed “recipient interest profiler” herein), and FIG. 7 illustrates in flow diagram form the operation of a typical system for profiling the interests of recipients in a cable television network, as published in U.S. Pat. No. 6,081,262. The use of this example provides one illustration of many of the known possible ways that data can be gathered to characterize the interests of the various recipients. This example is based on a cable television paradigm and represents a known method of gathering recipient profile data.

The recipient interest profiler includes a merge processor 600, a file server 602, a profile processor 604, and a broadcast server 605, connected to a plurality of set-top boxes 608-1 to 608-3, each of which serves an associated television set 609-1 to 609-3. Together, these components record network use by individual recipients, store and organize data associated with the network use, analyze the data to identify interests of an individual recipient, classify the individual recipient in an identifiable interest group, such as a demographic group, and deliver an advertisement targeted for the identified demographic group to the individual recipient. Merge processor 600, file server 602, and broadcast server 605 reside in a head end 610, typically operated by a media service provider, and are connected to a plurality of set-top boxes 608-1 to 608-3 through a distributed media delivery network 606, such as a satellite, cable, or fiber optic network. Profile processor 604 also resides in head end 610 and is connected to merge processor 600 and file server 602.

A set-top box 608 is a network media device comprising a processor, a memory for operating instructions and data storage, and a control interface for receiving recipient viewing commands from a remote control device or control panel. When it is connected to a viewing device, such as a television set 609 at a recipient premises, the set-top box 608 responds to and records the viewing selections (“event data”) of a recipient. At predetermined intervals, the set-top box 608 uploads this event data through the distribution network 606 to the merge processor 600 which communicates with the plurality of set-top boxes 608-1 to 608-3 through the distribution network 606. Merge processor 600 receives the event data from the set-top boxes 608-1 to 608-3, organizes the data, and stores the data in event lists arranged by recipient account.

File server 602 stores display data to be delivered to the plurality of set-top boxes 608-1 to 608-3 in response to a recipient selection. For example, file server 602 can contain digital copies of pay-per-view movies or commercials. The display data can be in the form of text, graphic elements, bit maps, or video stream. Graphic elements are simple display images such as rectangles, lines, or circles. In addition to storing and delivering display data, file server 602 also communicates with the plurality of set-top boxes 608-1 to 608-3, performing such functions as assigning each set-top box 608 to a demographic group and directing each set-top box 608 to tune to particular channels.

In contrast to the interactive sessions of file server 602, broadcast server 605 delivers a continuous stream of display data within a broadcast environment. Broadcast server 605 delivers multiple video streams on separate channels and, unlike file server 602, does not participate in dynamic interchange with the set-top boxes 608-1 to 608-3. Instead, the set-top boxes 608-1 to 608-3 tune to the particular channels that contain programming corresponding to their individual demographic groups.

Profile processor 604 receives event data from merge processor 600 and additional data from several other sources to construct a consumer profile of a recipient. In constructing a profile, profile processor 604 analyzes the data to identify a recipient's viewing habits and corresponding interests. In addition to merge processor 600, the other data sources preferably include an interactive selection list from an interactive television database 620, recipient data from a recipient registration database 622, billing data from an accounting database 624, and perhaps questionnaire data from a survey database 626 that stores recipients' specific responses to questions about their interests. Profile processor 604 uses an algorithm to systematically examine recipient profile information, to determine the particular demographic group of the recipient, and to choose an advertisement which appeals to the interests of the recipient and the demographic group. Once the analysis is complete, profile processor 604 instructs file server 602 to deliver a particular advertisement to the set-top box of the recipient. Profile processor 604 performs data source analyses and issues instructions concurrently among multiple recipients so that multiple recipients watching the same show can receive different advertisements.

In constructing a recipient profile, profile processor 604 receives the event data from merge processor 600 along with any other available data from other data sources. For example, profile processor 604 can receive additional data from an interactive television database 620, a recipient registration database 622, an accounting database 624, and a survey database 626. Interactive television database 620 provides data related to the services a recipient has purchased or used over interactive television, such as video on demand. Recipient registration database 622 provides all of the recipient data recorded at service initiation, such as a recipient's address and employer. Accounting database 624 provides recipient billing and purchasing information, such as service purchased, service rates, and payment aging. Finally, survey database 626 provides personal information gathered from recipients using questionnaires that solicit responses about viewing habits and purchasing interests.

### Set-Top Box Data Collection

FIG. 7 is a flowchart illustrating the steps involved in collecting and analyzing event data and delivering targeted advertisements for both the interactive session model and the broadcast model, according to a preferred embodiment of the present invention. In step 700 of FIG. 7, a recipient enters viewing commands into the set-top box (set-top box 608-1, for example) using a remote control unit, a control panel, or another device. In step 702, the navigator provisioned on the set-top box 608-1 records each command as event data in the memory buffer of the set-top box 608-1. The navigator uploads the event data to merge processor 600 and clears the memory buffer in step 704. The upload occurs at a predetermined interval or as commanded by merge processor 600, as shown in step 704a. For broadcast, the upload occurs when the set-top box first establishes communication with head end 610, as shown in step 704b. Steps 700 through 704 repeat continually as the recipient interacts with the networked media delivery system In step 706, merge processor 600 compiles the event data into event lists organized by recipient. With the event lists tabulated, merge processor 600 is ready to provide the information necessary to assess a recipient's viewing interests.

In step 708, profile processor 604 retrieves the event lists from merge processor 600 to begin shaping a recipient profile of the recipient. In addition, profile processor 604 draws information from all available databases, including, for example, interactive television database 620, recipient registration database 622, accounting database 624, and survey database 626. These databases provide profile processor 604 with additional recipient information such as address, employer, income level, favored manufacturers, banking habits, and products purchased through interactive television.

By analyzing the event data and the recipient data from the various databases, in step 710 profile processor 604 assigns a recipient profile to the recipient and matches the recipient profile to a demographic group. Having assigned a recipient profile and demographic group to the recipient, the system is ready to retrieve and deliver a targeted advertisement when an advertisement slot becomes available, as called for in step 712. For an interactive session, as shown in step 712a, the recipient makes a viewing selection that has advertisement management slots for targeted advertisements. In response, profile processor 604 chooses an advertisement corresponding to the recipient's recipient profile and demographic group, and file server 602 delivers the advertisement to the recipient in a menu screen or playlist. For the broadcast environment, as shown in step 712b, the set-top box 608-1 receives its assigned demographic group from file server 602 when the set-top box 608-1 first establishes communication with head end 610 or during subsequent communications.

This prior art system illustrates one example of a basic methodology for collecting recipient data, generating a recipient object interest profile, and using this data to select advertisements of interest for the recipient. While the system of FIGS. 6 and 7 were based on a cable television implementation, the basic concepts illustrated therein can be extrapolated and combined with aspects of other such known systems to create a recipient database for any system architecture and object placement.

### SUMMARY

The present multi-media object management system controls the retrieval of Object data that comprises an object representation (such as a product) and the integration of this Object Data into a corresponding selected one of the predetermined Multi-Media Object Locations which are components of the Multi-Media Program. This enables advertisers to precisely control product placement on a customized basis thereby to dynamically modify the content of the Multi-Media Program as it is delivered to the individual recipient. The present multi-media object management system takes the Master Program and creates the Multi-Media Object Locations with their associated Object Management Data, thereby to enable the system to populate these Multi-Media Object Locations with appropriate Objects which are selected on the basis of purchaser interest and appropriateness for the selected Multi-Media Object Location, as well as the interests of the Recipients. The Objects can be adapted to fit the selected Multi-Media Object Location and, once placed therein, can be protected from subsequent editing using a digital rights management process. There are a number of methods by which the Multi-Media Object Locations can be brokered, with International, National, Regional, Local, and Personal markets being defined as well as exclusive rights, conditional rights, all available to the purchaser by means of auction, predefined contracts, or other financial arrangements. Thus, the present multi-media object management system provides an adaptable yet dynamic service for the placement of objects into a Multi-Media Program, with the end product containing Object representations that are integral to the Multi-Media Program.

What is claimed as new and desired to be protected by Letters Patent of the United States is:

1. A multi-media object management system for dynamically controlling object placement into a master program to produce a multi-media program, comprising:
an object source that stores a plurality of objects and object characteristic data that defines at least one of: the content of an object, the class of object, identification of the owner of the object, and limitations on the use of the object;
content processor means, responsive to receipt of a master program that contains at least one multi-media object location, for producing object-ready content comprising both said master program that contains at least one multi-media object location that comprises an identified site within said master program and corresponding object management data comprising at least one of: the class of object, the object location, the time and place and extent in the master program where an object occurs, the number of dimensions that a given object has, and how long an object is enabled; and
object insertion processor means for dynamically inserting an object into a corresponding multi-media object location, comprising:
object reconciliation means, responsive to receipt of master program rule set data that defines at least one of: the content of an object, the class of object, identification of the owner of the master program, limitations on the use of the object, for reconciling said object characteristic data, said object management data, and said master program rule set data in selecting an object to populate said selected multi-media object location, and
object placement means for dynamically integrating said selected object into said selected multi-media object location to produce said multi-media program.

2. The multi-media object management system of claim 1 wherein said object reconciliation means comprises:
object matching means for matching ones of said content of an object, said class of object, and said limitations of the use of said object as defined in said object characteristic data and said master program rule set data; and
object blocking means, responsive to a failure of said object matching means to successfully match said object characteristic data and said master program rule set data, for inhibiting operation of said object placement means.

3. The multi-media object management system of claim 1 wherein said object reconciliation means comprises:
object matching means for matching ones of said content of an object, said class of object, and said limitations of the use of said object as defined in said object characteristic data, and said master program rule set data; and
substitution means, responsive to a failure of said object matching means to successfully match said object characteristic data and said master program rule set data, for selecting an alternative object to successfully match said object characteristic data and said master program rule set data.

4. The multi-media object management system of claim 1 wherein said object reconciliation means comprises:
object matching means for matching said class of object as defined in said object characteristic data, said object management data, and said master program rule set data; and
object blocking means, responsive to a failure of said object matching means to successfully match said object characteristic data, said object management data, and said master program rule set data for inhibiting operation of said object placement means.

5. The multi-media object management system of claim 1 wherein said object reconciliation means comprises:
object matching means for matching said class of object as defined in said object characteristic data, said object management data, and said master program rule set data; and
substitution means, responsive to a failure of said object matching means to successfully match said object characteristic data, said object management data, and said master program rule set data, for selecting an alternative object to successfully match said object characteristic data and said master program rule set data.

6. The multi-media object management system of claim 1 wherein said object reconciliation means comprises:
object matching means for matching how long an object is enabled as defined in said object characteristic data with a present time; and
object blocking means, responsive to a failure of said object matching means to successfully match said object characteristic data and said present time, for inhibiting operation of said object placement means.

7. The multi-media object management system of claim 1 wherein said object reconciliation means comprises:
object matching means for matching how long an object is enabled as defined in said object characteristic data with a present time; and
substitution means, responsive to a failure of said object matching means to successfully match said object characteristic data and said present time, for selecting an alternative object to successfully match said object characteristic data and said present time.

8. A method for dynamically controlling object placement into a master program to produce a multi-media program, comprising:
storing in an object source a plurality of objects and object characteristic data that defines at least one of: the content of an object, the class of object, identification of the owner of the object, and limitations on the use of the object;
producing, in response to receipt of a master program that contains at least one multi-media object location, object-ready content comprising both said master program that contains at least one multi-media object location that comprises an identified site within said master program and corresponding object management data comprising at least one of: the class of object, the object location, the time and place and extent in the master program where an object occurs, the number of dimensions that a given object has, and how long an object is enabled; and
dynamically inserting an object into a corresponding multi-media object location, comprising:
reconciling, in response to receipt of master program rule set data that defines at least one of: the content of an object, the class of object, identification of the owner of the master program, and limitations on the use of the object, said object characteristic data, said object management data, and said master program rule set data in selecting an object to populate said selected multi-media object location, and
dynamically integrating said selected object into said selected multi-media object location to produce said multi-media program.

9. The method for dynamically controlling object placement into a master program of claim 8 wherein said step of reconciling comprises:
matching ones of said content of an object, said class of object, and said limitations of the use of said object as defined in said object characteristic data and said master program rule set data; and
inhibiting operation of said step of dynamically integrating, in response to a failure to successfully match said object characteristic data and said master program rule set data.

10. The method for dynamically controlling object placement into a master program of claim 8 wherein said step of reconciling comprises:
matching ones of said content of an object, said class of object and said limitations of the use of said object as defined in said object characteristic data and said master program rule set data; and
selecting, in response to a failure of said object matching means to successfully match said object characteristic data and said master program rule set data; an alternative object to successfully match said object characteristic data and said master program rule set data.

11. The method for dynamically controlling object placement into a master program of claim 8 wherein said step of reconciling comprises:
matching said class of object as defined in said object characteristic data, said object management data, and said master program rule set data; and
inhibiting operation of said step of dynamically integrating, in response to a failure to successfully match said object characteristic data, said object management data, and said master program rule set data.

12. The method for dynamically controlling object placement into a master program of claim 8 wherein said step of reconciling comprises:
matching said class of object as defined in said object characteristic data, said object management data, and said master program rule set data; and
selecting, in response to a failure of said object matching means to successfully match said object characteristic data, said object management data, and said master program rule set data, an alternative object to successfully match said object characteristic data and said master program rule set data.

13. The method for dynamically controlling object placement into a master program of claim 8 wherein said step of reconciling comprises:
matching how long an object is enabled as defined in said object characteristic data with a present time; and
inhibiting operation of said step of dynamically integrating, in response to a failure to successfully match said object characteristic data and said present time.

14. The method for dynamically controlling object placement into a master program of claim 8 wherein said step of reconciling comprises:
matching how long an object is enabled as defined in said object characteristic data with a present time; and
selecting, in response to a failure of said object matching means to successfully match said object characteristic data and said present time, an alternative object to successfully match said object characteristic data and said present time.
